(19) United States
(12) Patent Application Publication
(10) Pub. No.: US 2008/0250914 A1
(43) Pub. Date: Oct. 16, 2008

(54) System, method and software for detecting signals generated by one or more sensors and translating those signals into auditory, visual or kinesthetic expression

(76) Inventors: Julia Christine Reinhart, Brooklyn, NY (US); Jane Agatha Rigler, Brooklyn, NY (US); Zachary Nathan Seldess, Brooklyn, NY (US)

Correspondence Address: MORGAN LEWIS & BOCKIUS LLP, 1111 PENNSYLVANIA AVENUE NW, WASHINGTON, DC, 20004, US

(21) Appl. No.: 11/786,881

(22) Filed: Apr. 13, 2007

(51) Int. Cl. G10H 7/00

(52) U.S. Cl. 84/645

(57) ABSTRACT

The present invention comprises an interactive system controlled by modifiable responsive sensors in which players can control auditory, visual and/or kinesthetic expression in real-time. As an auditory example of this system, one or more users can interact with accelerometers to trigger a variety of computer-generated sounds, MIDI instruments and/or pre-recorded sound files and combinations thereof. Sensor sensitivity is modifiable for each user so that even very small movements can control a sound. The system is flexible, permitting a user to act alone or with others, simultaneously, each user using one or more sensors, and each sensor controlling a separate sound. The sensors control elements of music: starting, stopping, generating higher and/or lower pitches, rhythmic complexity, looping patterns, restarting looping patterns, etc. This system allows users to record sounds for playback, to use pre-existing soundfiles, as well as to add unique soundfiles into the system.

### INTRODUCTION

Embodiments of the present invention comprise systems, methods and software that use the signal of one or more sensors as a triggering mechanism for interactively controlling, creating and performing visual or auditory expression, based on the detected signal from the sensor(s). Original visual, auditory or kinesthetic expression can be created and performed in real time and/or recorded for later playback.

Certain embodiments at the present invention allow for instrument sound and interactivity capability by including, a Gliding Tone instrument (an oscillator), a Groove File instrument (pre-recorded soundfiles) as well as a Rhythm Grid, which permit the invention of original rhythms in which general MIDI percussion instrument tones can also be used with the possibility of a MIDI expander to expand the selection of MIDI tones available. Visual imaging and tactile experience are also possible.

The interactive software of certain embodiments of the present invention permit the use of one or more sensors to create completely original auditory, visual and/or kinesthetic expression in real time, using a flexible combination of sounds and/or visual effects and/or tangible effects or sensations. Specifically, certain embodiments of the present invention allow the user to create works of original, unique composition that have never existed before. The system allows the user to compose something completely new, not to merely “conduct” the performance of a pre-existing work. The flexibility of this system involves a multiplicity of levels of combinations.

For example, one or more players can create multifaceted combinations of multiple kinds of auditory, visual and/or kinesthetic effects. As one example, one or more players can generate sounds from multiple different kinds of MIDI percussion instruments, each one with its own unique rhythmic pattern. Alternatively, the player(s) can generate sounds from one or more Groove file instruments, Gliding Tone instruments and MIDI melody instruments—each having its own tempo. Or, each can play at the same global tempo, in the same global key (if key applies to that instrument, for example). The combination of multiplicity of instruments allows for constant discovery of sounds, rhythms and sonic relationships by the players. Signals can be translated into visual expression or kinesthetic sensation just as readily.

Adding additional sensors to certain embodiments of the present invention can expand the capability for generating auditory, visual or kinesthetic expression. In addition, the built-in design of certain embodiments, allows the player(s) versatile possibilities for a wide range of sensors and sensor interfaces to choose from.

Certain embodiments of the present invention are capable of recording as well as storing previous performances and are specifically designed to facilitate and enhance artistic performances, rehearsal, and educative techniques. Certain embodiments of the present invention are designed so that a player's physical or mental abilities will not limit the player's ability to use the invention. Certain embodiments of the invention can also be used in therapy, industry, entertainment, and other applications.

Certain embodiments of the present invention are directed toward simplified interactive systems whereby the hardware interface(s) involve only one sound module (but can be expanded if desired) and one or more sensor(s). The module can be designed as a stand-alone system or may be designed to be attached to any host computer. Because the module may be used with an existing, pre-owned host computer, it is reasonably cost-effective. Use of auditory, visual or kinesthetic emitters (e.g. speakers, visual images on a computer monitor, a laser display, overhead screens/projectors, massage chairs, water shows, movements of other objects or devices, for example spray paint) enhances review (observation/reflection) of the product of the player(s) efforts.

The graphic user interface (GUI) design on the screen of certain embodiments of the present invention is intended to be used by a wide range of users, including human(s) of any age. It is designed to have a professional look, but still be easy to use. The simple user interface design on the screen has been designed for intuitive interaction for any user capable of controlling a computer or other device capable of causing the emission of auditory, visual or kinesthetic stimuli.

Certain embodiments of the present invention allow for unlimited expansion of the sound, visual, and/or tactile (kinesthetic) library, as any file in standard format can be added to the library and controlled through the sensors. These additional files can be from any user-purchased library using standard file formats, self created recordings or files obtained from any other source. A unique feature of certain embodiments of the present invention allow any user to create and record any audio file and incorporate it into this system to be used as a timbre. This includes being able to record an original performance (or the environment) and then use that recording as a novel soundfile for an original timbre. Adding files to the library is very simple and fast and new files are available for use immediately. Using certain embodiments of the present invention, higher-level performers also have the option to expand the library of MIDI controlled timbres beyond the set of 127 choices available under general MIDI by connecting the system to any commercially available MIDI expander, benefiting through this from near-perfect sound emulation and broader variety of modern MIDI technology.

Certain embodiments of the present invention are designed to facilitate use in educational and therapeutic settings, as well as providing an artistic performance outlet for a wide range of players and skill levels—from children making music for the first time to professional musicians.

Certain embodiments of the present invention are capable of providing built-in threshold level adjustment(s), which allow a user to adjust the level of intensity (parameters) of signal from the sensor that is necessary in order to generate a signal thereby, for example, allowing a player with limited mobility to generate auditory, visual and/or kinesthetic expression (i.e. to interact with the computer program to generate auditory, visual and/or kinesthetic signal) with very little movement or physical exertion. The sensor sensitivity threshold level can be adjusted to acknowledge various movement possibilities/capabilities for a wide variety of users.

Certain embodiments of the present invention permit the user, by generating signals from the sensor(s), to control pre-recorded audio tracks to: (1) suddenly initiate back to the beginning of the track (or looped playback), much like a DJ would “scratch” a vinyl recording to another place on the disc, and/or (2) to stop, and/or (3) to start playing at any point. It is contemplated that visual media could be manipulated by a similar process.

In effect, the player(s) can transform(s) any pre-recorded track (i.e., soundfile) into a new, original instrument. The recording is “played” much like a percussion instrument would be struck, but in this case the player can “strike” the sensor in the air or against an object, another hand, leg, or by attaching the sensor to another body part or moving object. This “air percussion” instrument sounds real (the sound recordings are all of real samples of timbres of real instruments), and directly (and precisely) corresponds to the player's physical movements.

Certain embodiments of the present invention control the pitch of certain musical instruments by the frequency of signal generation from the sensor(s). Other aspects of auditory, visual and/or tactile expression may similarly be controlled by varying the signal received from the sensor.

Certain embodiments of the present invention allow the user (s) options to both create one or more unique rhythmic looping patterns and to then control the loop pattern by (1) suddenly re-initiating the pattern from the beginning, (2) stopping in the middle of the pattern, and/or (3) continuing to play the pattern, all on the basis of the signal from the sensor. This essentially creates a new rhythm instrument which can be played in a variety of ways. The original loop rhythmic pattern designed by the user can be played steadily if the sensor is triggering ongoing data. If the sensor is stopped, the loop rhythmic pattern will stop. If the sensor is reinitiated, the rhythmic pattern will continue. In certain embodiments, the Restart Sensitivity option allows the user to restart the loop rhythmic pattern from the beginning of the loop, essentially giving an effect of “scratching,” restarting the loop before it is finished. Through this gesture, a new original kinesthetically corresponding rhythmic pattern will be generated.

In certain embodiments of the present invention one or more users may play together and interact not only with each other, but also with other users, such as, but not limited to, artists, musicians and dancers, who can respond/react to the auditory, visual and/or kinesthetic expression generated.

Certain embodiments of the present invention enable any user with any skill level to create unique and rich auditory, visual expression and to experience both improvisation as well as composition. No music or artistic knowledge, skill at playing musical instruments or creating art, or advanced computer skills are needed to be able to use the embodiment beyond basic knowledge of computer control.

Certain embodiments of the present invention, when generating auditory expression, are able to control the specific key in which sound is generated. Further, the melodic modality of the sound generated can also be controlled, and the number of tones generated can be restricted as desired. One practical application of this feature is to enable a teacher to train a student to hear certain tones and/or intervals. Certain embodiments of the present invention can also be used by a student of music for self-study in the same way. Certain embodiments of the present invention encourage/promote users to create their own original musical composition.

Certain embodiments of the present invention generate particular auditory, visual and/or kinesthetic expression based upon the signal received from one sensor while not limiting the range of options for expression based upon signals from any other sensor. Each sensor may be used to generate a unique auditory, visual and/or kinesthetic expression, or the signal from each may be used to generate a similar auditory, visual and/or kinesthetic expression. For example, each sensor can be used to generate sound from the same timbre of musical instrument in the same key and melodic melody, or every sensor can be set to generate a different auditory, visual and/or kinesthetic effect, or any combination in between.

Certain embodiments of the present invention have a rhythmic “chaos” level for advanced users, allowing for the more rapid shaking or moving sensor to increase the more random rhythmic activity of auditory, visual and/or tactile stimuli. For purposes of understanding certain embodiments of this invention, some terms are defined below (the specification contains additional definitions and details):
Category=melody or rhythm (type of instrument).
Conduct=guide one or more musicians through the performance of a piece of music by providing hand signals and/or gestures which, give performers cues such as: to start and/or to stop, change the volume or tempo of their predetermined part or to start improvising over the accompaniment of the other performers in the group.
Compose=to create an original work.
Dynamics=changes in volume of sonic output over time
GUI=graphical user interface, the display seen on the computer screen when the program is loaded or in use, typically an interactive display.
Guide=a user controlling the GUI (can be a player or other person, but need not be a person).
Instrument Category=instrument=a distinct method of generating a sonic output such as (in certain embodiments of the present invention) melody instrument, gliding tone instrument, rhythm instrument, groove file instrument, etc.
Metronome=traditionally a device that indicates the tempo by generating clicking noises to represent each beat per minute combined with a visual representation of the beat, for example, a swinging pendulum or a blinking light. In certain embodiments of the present invention, a blinking light is used to indicate the beats per minute and the clicking noise can be turned on or off.

MIDI=MIDI (Musical Instrument Digital Interface) is an industry-standard electronic communications protocol that enables electronic musical instruments, computers and other equipment to communicate, control and synchronize with each other in real time. MIDI does not transmit an audio signal or media—it simply transmits digital data “event messages” such as the pitch and intensity of musical notes to play, control signals for parameters such as volume, vibrato and panning, cues and clock signals to set the tempo . . . (Wikipedia definition).

Modality=type of scale used by MIDI instruments, e.g. major, minor, blues or any user-defined group of notes.

Melody=randomly or deliberately chosen sequence of pitches, including variances in length, timbre, and volume of each pitch.

Pitch=frequency (the sound users and audiences will hear).

Player=a user that interacts with the system through one or more sensors, thus triggering an auditory, visual or kinesthetic output, for example a player can be, but is not limited to, a person, animal, plant, robot, toy, or mechanical device. Some examples of a player are, but are not limited to, a musician, an acrobat, a child, a cat, a dog, the branch of a tree, a robot (for example, a child's toy or a robot used in an industrial setting), a ball, a beanbag, a kite, a bicycle, a bicycle wheel.
Sensor interface=a system that reads sensor data, interprets it into data the computer understands and communicates this interpreted data to the appropriate program (examples of some embodiments are provided in the summary of the invention).
Sonic result/effect/output, etc.=sound that users and audiences hear, including the melody, key, timbre, tempo and dynamic changes in the performance.
Tempo=number of beats per minute (bpm) set for rhythmic and melodic instruments in certain embodiments of the present invention.
Tone=timbre (color of the sound).
Tonic=base note (aka key) of the scale used by MIDI instruments; scale (e.g. C, G, F).
Timbre=sonic quality of available MIDI instrument or soundfile selections, e.g. Grand Piano vs. Honky Tonk Piano, or violin vs. saxophone, etc. Timbre is used in this document to distinguish individual instrument voices from different methods of sonic generation (i.e., instrument categories).
User=player or guide (need not a person), sometimes the terms user and player or user and guide may be used interchangeably, also a player can be a guide and vice versa.
Volume=amplitude (loudness of sonic output that users and audiences hear)

### SUMMARY OF THE INVENTION

It is therefore an object of the present invention to provide a system, method and software for detecting the signals generated by one or more sensors and translating those signals into auditory, visual, and/or kinesthetic expression.

More particularly, it is the object of the present invention to provide a novel system, method and software for the creation and composition of original auditory, visual and/or kinesthetic expression in real time. The system is designed to permit one or more users to create original sequences and combinations of sounds, visual images, and/or kinesthetic experiences based upon selection of an output type and source and manipulation of that output via signals received from sensors.

One skilled in the art will recognize that many different types of sensors may be used, and a combination of different types of sensors may also be used. Similarly, any of a number of interfaces may be appropriate to translate the data from the sensors. Further, one skilled in the art will recognize that there is little difference in the output necessary to generate a variety of sounds, the output necessary to generate visual imagery, and the output necessary to generate kinesthetic experiences.

In this context, one skilled in the art will recognize that a description of a device using accelerometers and generating output in the form of sound is not significantly different from one using a different type, or types, of sensors and generating output in the form of any auditory, visual and/or kinesthetic experience.

One way to accomplish this is, in certain embodiments of the present invention, for each user to hold or wear one or more accelerometers. Accelerometers are used to detect motion and to transmit a signal based upon that motion to a sensor interface, which is part of a custom computer program that can be loaded onto a host computer. The range of motion of the player is assessed and then scaled to produce sound over the same volume range regardless of how wide or how limited the player's range of motion is. In other words, someone with a limited range of motion can produce sounds just as loud, and as quiet and just as rich, as someone with a wide range of motion. For simplicity of explanation, this description is written as though the player is a person, but it is understood that a wide range of non-human players are also possible.

Each player will use at least once accelerometer. Each accelerometer can measure motion 3-dimensionally—over the x, y, and z axes independently. It is recommended, but not required, that the program used be one customized to filter noise from the system and to ensure that reproducing a particular motion will reproduce the same sound. The system can be programmed so that the same range of motion, regardless of the axes (direction) of that motion, will produce the same sound—or so that variations in the axes of motion, will produce variations in sound.

In order to provide a wide range of creative opportunities, the system and method use a variety of types of sound. Each player may use one, or more than one, accelerometer. Multiple accelerometers may be used with the same instrument and timbre, with similar timbres, or each accelerometer may be used to generate sound from a completely different instrument and timbre. Pre-recorded soundfiles may be used, as may the general MIDI files that are provided as a standard feature on most laptops and desktops. Additional richness and variety may be added by using a MIDI expander box, or equivalent, to access different and richer sounds. In addition, some novel sound types are provided. It is envisioned that custom recorded sound-files may also be used so that the range of sounds available may be expanded beyond those initially provided and so that individuals may develop their own novel sounds and sound combinations, including being able to save an original work created using the present invention, and then accessing that recording to use as a sound for further manipulation.

One skilled in the art will recognize that other sensor types may be used in conjunction with or in lieu of accelerometers, and one another. Examples of other sensors are, but are not limited to: a light sensor, a pressure sensor, a switch, a magnetic sensor, a potentiometer, a temperature (thermistor) sensor, a proximity sensor, an IR (infrared) sensor, an ultrasonic sensor, a flex/bend sensor, a wind or air pressure sensor, a force sensor, a solenoid, or a gyroscope; a sensor capable of detecting a change in state where the change in state is a change in velocity, acceleration, direction, level of light, pressure, on/off position, magnetic field, electrical current, electric “pulse,” temperature, infrared signal, ultrasonic signal, flexing or bending, wind speed or pressure, air pressure, force, or electrical stimulus.

A sensor interface is a system capable of translating data from an input device, such as a sensor, to data readable by a computer. Those skilled in the art will recognize that other interface types may be used in lieu of, or in conjunction with, a MIDI sensor interface, as well as with one another. Some examples of interfaces are but are not limited to: an Arduino interface, an Arduino BT interface, an Arduino Mini interface, a Crumb 128 interface, a MIDIsense interface, a Wiring I/O board interface, a CREATE USB interface, a MAnMIDI interface, a GAINER interface, a Phidgets interface, a Kit 8/8/8 interface, a Pocket Electronics interface, a MultiIO interface, a MIDItron interface, a Teleo interface, a Make Controller interface, a Bluesense Starter Kit interface, a microDig interface, a Teabox interface, a GluiON interface, a Eobody interface, a Wi-microDig interface, a Digitizer interface, a Wise Box interface, a Toaster interface, or a Kroonde interface; a sensor capable of translating a signal from and to a communication protocol comprising: USB, general, MIDI, Serial, bluetooth, Wi-Fi, open-sound control protocol, WLAN protocol (wireless area network), CIDP (user datagram protocol), TLP (transmission control protocol), FireWire 400 (IEE-1394), FireWire 800 (IEE-1394B), USB/HID, USB/Serial, Bluetooth/HID, USB, Ethernet, OSC, SPDIF, Bluetooth/MIDI, UDP/OSC, FUDI, Wireless (UDP via radio)/OSC, and other transmission and/or communication protocols, including any yet undeveloped communication protocols that allow the flow of data between computer units.

One application of this technology is in the educational context where it may be used to provide certain disabled individuals with an outlet to express themselves through music and sound.

An additional application of this technology is in therapy and research—it may be able to be refined to allow a person who cannot speak to otherwise communicate through sound. It is conceived of that there are numerous possible applications. Some additional examples are, but are not limited to:

It can also be used in physical therapy to help someone develop their range of motion.

It can be used in conjunction with exercise to make exercise more fun or to guide a person's exercise routine via auditory cues.

It can be used for musical performances by those trained in music as well as those with little or no training.

It can provide musical, or other sound, accompaniment to an acrobatic routine or show, as well as to an animal performance, for example by attaching sensors to the performer(s) or other entertainer(s).

It can be used for amateur or professional entertainment by attaching sensors to children, toys, pets, bicycles, kites, etc.

It can be used for relaxation therapy. By attaching the accelerometer to something that moves gently and gracefully, for example the branch of a tree, or suspending the sensor as a wind chime, and then programming the system to match that motion to a soothing sound. In that way, the invention may be able to provide soothing tones and relax the target, as would an audio recording of a forest brook, a seashore, etc.

The present invention can also be used in industry—if attached, for example, to robots on an assembly line, the operator can have auditory as well as visual cues to monitor performance of the robots. It is envisioned that, by this means, the operator may register a malfunction based on deviations in the expected sound before the problem becomes visually evident. In this way, it may be possible to intervene at an earlier stage and thereby reduce hazards and save the company money from injuries, lost production or damage to machines.

The present invention may also provide visual cues designed to correspond with the sound variations produced by each sensor individually. Examples of visual cues are, but are not limited to, sine waves, “zig-zag” lines (such as on a heart monitor or seismograph), a bar graph, pulsating color blurbs, 3-D figures moving through space; photographs, movie clips or other images that are cut up, re-arranged, or otherwise manipulated. Many more embodiments are possible and are discussed elsewhere in this document. The invention contemplates that the amplitude of the visual cue will increase with the intensity of the signal received and hence the volume of the sound generated. It is envisioned that the visual cues generated by one or more sensors can be overlaid or combined, or that the guide can focus on cues from only one sensor at a time. These visual cues can be used for entertainment or to visually monitor the activity of the player, again providing changes in visual images based on changes in motion or routine.

The present invention can be used for real-time sound generation or may record the sounds generated by the players for playback at a later time. Soundfiles recorded in this way, as well as those available from other sources, may be selected as a timbre and further manipulated in one or more subsequent performances.

The present invention can be calibrated for a range of motion. A threshold may be set so that relatively very small motions will fall below the threshold and therefore will not generate any sound. This is useful, for example, if the player is a person who tends to “fidgit.” In such an instance, the small, unintentional, random (or repetitive) motions will not generate sound.

### BRIEF DESCRIPTION OF THE DRAWINGS

For better understanding of the present invention, its preferred embodiments are described in greater detail herein below with reference to the accompanying drawings, in which:

FIG. 1 is a block diagram schematically showing an exemplary system comprising one or more sensors (S-1 to S-n), a sensor interface, a computer, and one or more sound emitting systems (SES-1 to SES-n) in accordance with a first embodiment of the present invention;

FIG. 2 is a screen shot of the Graphical User Interface (GUI) showing an exemplary set of preliminary options in the method of using the present invention.

FIG. 3-9 are screen shots of the GUI of a first embodiment showing an exemplary set of steps for selection of a category of instruments (in this case melody), a general instrument type (in this case, melody), and then the specific MIDI (Musical Instrument Digital Interface) timbre the player will use.

FIG. 10 is a screen shot of the GUI of a first embodiment showing an exemplary set of steps for adjusting the sensitivity after selection of a category of instruments (in this case melody), a general instrument type (in this case, melody), and the specific MIDI timbre the player will use.

FIG. 11-17 are screen shots of the GUI of a first embodiment showing an exemplary set of steps for selection of a category of instruments (in this case melody), a general instrument type (in this case, gliding tone), and then the specific timbre the player will use.

FIG. 18-21 are screen shots of the GUI of a first embodiment showing an exemplary set of steps for selection of a category of instruments (in this case rhythm), a general instrument type (in this case, rhythm grid), and then the specific MIDI timbre the player will use.

FIG. 22-25 are screen shots of the GUI of a first embodiment showing an exemplary set of steps for selection of a category of instruments (in this case rhythm), a general instrument type (in this case, groove file), and then the specific timbre the player will use.

FIG. 26-33 are screen shots of the GUI of a first embodiment showing various options in regard to different instrument and timbre choices, as well as various global options.

FIG. 34 is a screen shot of the GUI of a second embodiment showing an exemplary selection of two categories of instruments, four general instrument types, and some options for the specific timbre the player(s) will use. The global control settings are part of the transport template visible herein.

FIG. 35 is a screen shot of a GUI of a third embodiment. In this embodiment the GUI shows a multiple number of events and actions simultaneously.

### DETAILED DESCRIPTION OF CERTAIN EMBODIMENTS

First, it should be appreciated that the various embodiments of the present invention to be described in detail herein are just for illustrative purposes and a variety of modifications thereof are possible without departing from the basic principles of the present invention.

### General Setup of the First Embodiment

### Description of Exemplary Diagram of System

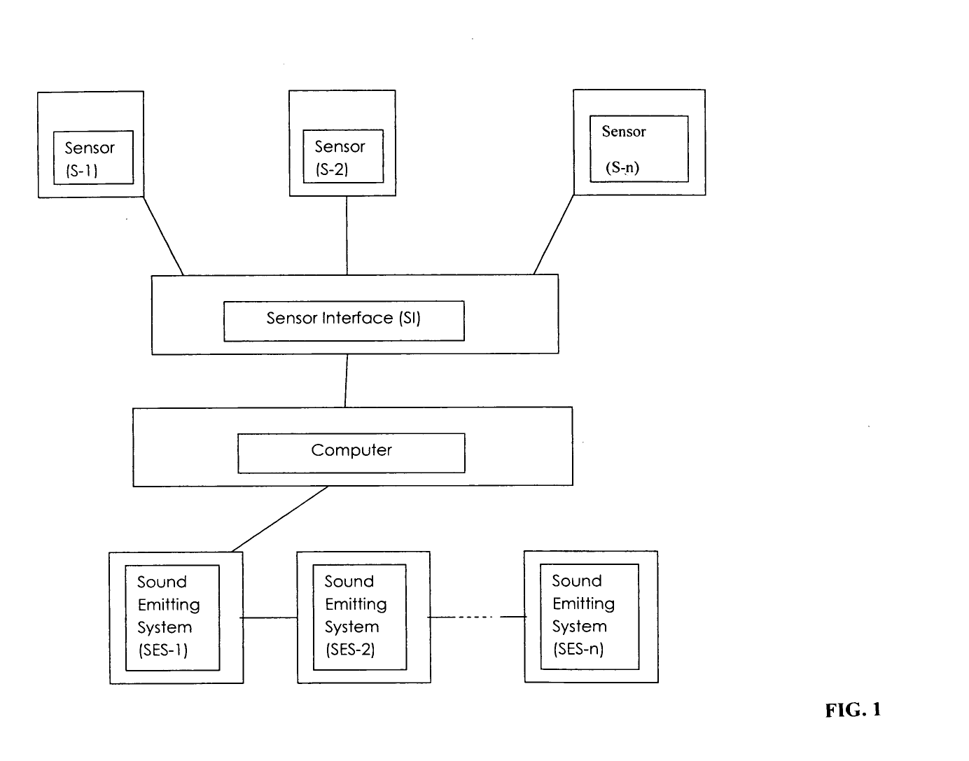

FIG. 1 is a block diagram schematically showing an exemplary general setup of a system comprising one or more sensors, a sensor interface, a computer, and one or more sound emitting systems in accordance with a first embodiment of the present invention. In the illustrated example, a sensor interface, which can be easily connected to the host computer via Firewire, UBS or other connector, is shown as a separate element of the system. The host computer typically will come with the capability to handle general MIDI files, but a MIDI interface is needed to convert the data from the sensor interface to the computer in a MIDI readable format. The MIDI interface can either be incorporated into a sensor interface (as shown here) or may be a separate element that can be connected to the host computer via USB, Firewire or other communication and/or transmission protocol.

In the preferred embodiment, the sensors are motion sensors which may be hand-held, attached to a body part, or attached to any other person, pet, object, etc. capable of moving. The embodiment depicts use of motion sensors that relay information to the computer directly through wires, but one skilled in the art would recognize that wireless transmission is equally feasible. The embodiment also envisions that the sensors need not be limited to motion sensors and need not be placed only on humans.

Sensors may be analog or digital. Analogue sensors may be converted to digital by setting a sensitivity threshold so that any signal below the threshold is interpreted as “off” and any signal above the threshold is interpreted as “on.” Some possible sensor types include but are not limited to: accelerometer, light, pressure, switch, magnetic, potentiometer, temperature (thermistor), proximity (IR, ultrasonic), pressure, flex/bend sensor, wind or air pressure sensor, force sensor and solenoid.

Some examples of placement include, but are not limited to, one or more persons, animals, plants (such as the branch of a bush or tree), robots, bicycles, bicycle wheels, beanbags, balls or any combination thereof.

In the first embodiment, each motion sensing/transmitting system relays a signal to the host computer via a sensor interface. The signal is then processed by the computer in conjunction with the MIDI interface, as needed, and a resulting sound is emitted via a sound emitting system(s). The instant invention envisions the sound emitting system as being, for example, but not limited to, one or more speakers that receive a signal from the host computer.

A sensor interface is an I/O device (an interface) that converts sensor data into computer readable format. Examples of interfaces are, but are not limited to: USB, general, MIDI, Serial, bluetooth, Wi-Fi, open-sound control protocol, WLAN protocol (wireless area network), CIDP (user datagram protocol), TLP (transmission control protocol), FireWire 400 (IEE-1394), FireWire 800 (IEE-1394Bh). One skilled in the art would recognize that any yet to be developed signal transferring protocol between computer units could be substituted for any of the aforementioned interfaces.

In the first embodiment, the sensor interface incorporates a MIDI interface which this translates the sensor data information into MIDI information that the computer can read. The MIDI interface may be a stand-alone unit or may be internal or external to any hardware component. It is contemplated that any one, or more than one, of a variety of sensor interfaces could be used (some of which could include MIDI interfaces) and that the system could use more than on type of sensor interface concurrently. Some commercially available examples of sensor interfaces are: HID (USB/HID), Arduino (USB, Serial), Arduino BT (Bluetooth), Arduino Mini (USB), Crumb 128 (USB, Serial, MIDIsense (MIDI), Wiring i/o board (USB/Serial), CREATE USB Interface (CUI) (USB, Bluetooth/HID), MAnMIDI (MIDI), GAINER (USB, Serial), Phidgets Interface Kit 8/8/8 (USB), Pocket Electronics (MIDI), MultIO (USB/HID), MIDItron (MIDI), Teleo (USB), Make Controller (USB, Ethernat (can be used simultaneously)/OSC), Bluesense Starter Kit (USB), microDig (MIDI), Teabox (SPDIF), GluiON (???/OSC), Eobody (MIDI), Wi-microDig (Bluetooth/MIDI) Digitizer (MIDI), Wise Box (???/OSC), Toaster (Ethernet (UDP)/OSC, MIDI, FUDI), and Kroonde (Wireless (UDP via radio)/OSC, MIDI, FUDI). (Information on types of interfaces per Wikipedia.) One skilled in the art would recognize that other kinds of sensor interfaces can be substituted for one or more of the above commercial interfaces.

### Outline of Preferred Embodiment

The preferred embodiment includes an interactive music composition software program controlled by sensors and designed with the needs of people with disabilities in mind, but not made exclusively for that population. The player(s) of this invention can use accelerometer sensors that are either held or attached to the person to trigger a variety of sounds, general MIDI instruments and/or prerecorded soundfiles. The original goal of this embodiment was to empower students with disabilities to create music and encourage them to perform with other musicians. The capabilities of this invention make it suitable for use by other populations as well.

The preferred embodiment uses a graphical cross-platform compatible programming system for music, audio and multimedia such as Max/MSP and can be used by a user in several different settings, for example, one being a stand-alone version on a portable data carrier such as, but not limited to a CD-ROM that contains all program elements and data files necessary to run the invention on any host computer connected to the sensor interface, and another being a program in which the user can make updates and changes to the program, thereby creating a customized version of their own performance system.

It is contemplated that this system can be offered in two versions. The standard version would contain all software and components necessary to use the program or to install the software on any host computer regardless of operating system or whether or not the user owns Max/MSP, or a similar program. The expert version would require the user to also have Max/MSP, or similar program, installed on the host computer. The expert version would contain a feature allowing the user to create custom device features or to re-write any aspects of the program. It is envisioned that advanced users will be able to interact and share custom features (“patches”) via an open-source model comparable to the one created by users of the Linux operating system or other open-source applications.

It is also contemplated that the standard version, and possibly the expert version, can be incorporated into a physical stand-alone unit so that the system can be used without being installed on a host computer.

The present invention is an interactive music composition device controlled by motion sensors initially designed for children with disabilities to be used as an educative, therapeutic and emotionally rewarding outlet for this population and their teachers, therapists and parents. This system was built to allow the physically and cognitively challenged population to create new music by using motion sensors which are held or attached to a person's wrist, arm, leg, etc. The motion sensors are designed to be individually modified for each person so that even the slightest movement can be tracked and become a control for composing music electronically. Up to four people can play simultaneously, each person experiencing the cause and effect of their movements which directly correspond to the rhythm, melody and the basic elements of music composition. We have achieved the goal of creating a useful and fun new instrument to the extent that children and adults can easily play with this software with little knowledge of how it works.

Instrument sounds start when the sensor is moved, shaken, agitated or wiggled, and stop after the sensor is inert for a second or two.

The main tempo, tonality and volume may be determined by the guide, but the rate of notes (½ notes v. 1/16th notes, for example) is completely controlled by the player's moving of the sensor. Whether the pitches rise or fall, start or stop, or contain rhythmic complexity or not, is determined by the movements of each player.

Music can be created spontaneously in real-time as well as recorded for play-back for documentation, performance, or composition. This invention encourages spontaneous music-creating but also promotes the composition process, which arises out of the structure and form performed.

The elements of music: starting, stopping, pitch, rhythm, volume, and tempo are introduced through experiential playing of this instrument.

Players (and guides) can conduct one another and create form and structure by either writing it out on a board, recording their work or through memory games.

Unlike other interactive electronic devices, this invention incorporates not only MIDI sounds, but pre-recorded soundfiles as well as electronic sounds. This invention, based upon the kinesthetics of performance, is specifically designed for a population of students who are not otherwise capable of playing musical instruments.

This invention is also effective for cognitively involved players as well as emotionally distressed young adults, and those with discipline problems. Players are able to recognize their own chosen timbre of instrument and make cognizant choices about the form, structure and rhythm of the music.

An important aspect of the present invention is that it can be modified for each player's sensitivity of movement. In this way a person can learn how to use this invention much in the same way a non-disabled person can learn a musical instrument. A person with limited mobility can immediately experience the cause and effect of sound being created by a particular movement. The guide can guide the player's experience by adjusting the sensitivity of the invention to match the player's learning curve and skill level, to make sound production more challenging if desired—so that either a greater movement, or a lesser, more refined motion, will generate tones.

A signal is generated by a sensor, such as an accelerometer, and sent to a sensor interface which is supported by a host computer. The sensor interface is envisioned as a hardware and/or software system that may be installed on a host computer or may be produced as a stand-alone system with a computer interface. The signal sent can convey information in regard to the x, y, and z axes independently or can interpret the signal as being from only one or two dimensions, regardless of the dimensionality of the actual motion.

In preparing to use the system, a scaling/calibration cycle can be run. This cycle permits a user to scale the sounds to be emitted versus the spectrum of signal range signals, e.g. acceleration, which the sensor will be used in during that session of use. As a mathematical analogy, as the player moves the accelerometer, measurements are taken and registered as points on a numeric scale from one to one hundred. A mean is calculated and the variances from the mean to the extremes of the range are measured and then normalized so that whether the player's motion generates an acceleration of one inch/second/second or 10 miles/sec/sec, the sound produced is comparable.

This is especially useful if more than one sensor is to be used because such a cycle will serve to keep the ranges of sound consistent so that the signal(s) from the sensors fall within approximately the same range regardless of the differences in the signal produced by respective sensors, or by respective users. Specifically, in the example where the sensors are accelerometers, if the sound emitted was directly proportional to the player's acceleration then, for example, the sound made by a tall adult moving his arms might drown out that of a young child, simply because the adult's arms are longer and therefore his range of motion is much greater, thereby creating a greater arc length when the adult's arm is moved the same number of degrees. Assuming the child and the adult can each move their arms in an arc over the same number of degrees in the same interval of time, because the adult's arms are longer, if the adult's arms are extended, the adult's hand will move faster than the child's (greater velocity, so greater acceleration is needed).

By utilizing the scaling/calibration feature of the present invention, the relative ranges of acceleration of the child and adult can be scaled/calibrated to emit the same range of sounds.

In the preferred embodiment, the GUI analyzes the signals from the range of acceleration over a period of time and scales the sensitivity of response so that the range of the sound emitted matches the range of acceleration. This is typically done during a preliminary calibration/scaling period, but can be re-adjusted as desired during use. The GUI can also determine the sensitivity threshold for each motion-sensing/transmitting system so that movements (acceleration) below that threshold will not generate any audible sound. This scaled/calibrated data is then fed back into the system and sent to the appropriate subprograms in the musical instrument data bank.

Sensor sensitivity may be manually set, and a category of instruments may be selected. In addition, the global control panel, visible in this embodiment at the bottom of the screen in the screen shots that follow, permits adjustment of scale (e.g. major, minor, blues, mixolydian, and others), key (“tonic scale,” C3 in this example), tempo (76 in this example but, in the preferred embodiment, range is from 40-200 beats/minute (“bpm”)), and whether or not tempo for all instruments is independent (set manually) or synchronized with the groove file selection.

Selection of any of these options, including those in the global control panel, can be made at any time. In the preferred embodiment, the global control panel has preset default settings—scale is set to major, tonic scale (labeled as “key control”) is set to C3, tempo control is set to 76, and tempo is set manually, which means that the tempo selected for each instrument and timbre is the tempo that will be used for it. Other values may be selected, and one skilled the art would recognize that other defaults may be used.

In the preferred embodiment, the global control panel is a separate pop-open window that can be concealed or revealed based upon a selection by the user. The global control panel can contain the control adjustments for: volume, key, tempo, modality, recording, saving, loading playback of recorded files.

In the preferred embodiment, pressing the space bar on the computer keyboard, or using the mouse to click on the corresponding start/stop bar on the GUI provides a global start/stop control for sound generation. In the preferred embodiment, the bar is displayed as one color (gray, for example) if not pressed/selected, and no sound is generated by any player regardless of that player's motions. When the bar is pressed/selected, the GUI shows it in a different color (green, for example) and sound is generated by all players with profiles in the system. As one example of the utility of this function, by simply pressing the space bar or clicking the mouse on the bar on the GUI, a teacher may use this to stop all sound generation in order to control student behavior in a classroom. One skilled in the art would recognize that individual start/stop functions are easily programmed variations on the preferred embodiment.

The GUI permits a guide to further customize the type of sound generated. In the preferred embodiment, there are four selection criteria used by the global control program. It is envisioned that one skilled in the art would be able to vary the number of criteria used.

In the preferred embodiment, a guide can choose the category of instrument and the instrument the player will use. Selections may be made so that each sensor has its own sound, or so that one or more may use the same sound(s). Sounds can be selected from, but are not limited to, gliding tone instruments, melody instruments, rhythm grid instruments, and groove file instruments. General MIDI instrument and/or soundfiles may be used. These are merely examples and the instrument is not limited only to these instruments and timbres. The present invention also contemplates that the soundfiles could include, but are not limited to, sirens, bells, screams, screeching tires, animal sounds, sounds of breaking glass, sounds of wind or water, and a variety of other kinds of sounds. It is an aspect of the present invention that soundfiles can be generated and recorded in real time. It is an additional aspect of the preferred embodiment that those soundfiles may then be selected as a timbre and manipulated further by a player through sensor activity and through selections made in the global control panel. The present invention contemplates that the timbres available to MIDI instruments can be expanded beyond the 127 choices available under the General MIDI Standard by connecting any commercially available MIDI expander to the host computer, thus improving quality of sound and expanding timbre variety.

Once a guide has selected a category of instruments and an instrument, the guide can then select a specific instrument timbre and can customize the type of sound the instrument will create in response to signals received from the sensor(s). In the preferred embodiment, this is done via a four-step process. The guide may designate synchronization of the tempo of the selected instrument with the other instruments, scale type (e.g., major, minor, etc.), tonic scale (e.g., key, such as B-flat, C, etc.), and tempo (e.g., any number between 40 beats per minute (“bpm”) and 200 bpm). These four steps may be done in any order. If the guide does not designate choices, the program will default to a predetermined set of settings, such as major scale, C tonic scale, 76 bpm and manual synchronization. It is envisioned that steps may be combined, added or removed, and that other default settings may be programmed in.

Once these selections have been made, signals from the sensors, as controlled by the player(s)'s actions, can be recorded. Depending on whether the guide designated the synchronized tempo option, the signals for each player are then either synchronized with the signals from the other players or are processed individually. In an alternative embodiment, all the signals for all the players are automatically synchronized and there is an option to either synchronize the signals of all the players with the groove file timbre, if one is selected, or to split off the groove file from the synchronized set of other signals. If more than one groove file is selected, the most recently made set of choices will dominate previous choices. In other words, if two players selected groove file instruments, and the first one choose to synchronize tempo but the second one chose not to, the second set of choices entered will control and tempo will not be synchronized. Similarly, if two groove file instruments are selected and the first has a tempo of 80, while the 2nd has a tempo of 102, and synchronization of all players with the 2nd groove file is selected, the tempo for all instruments will be 102, regardless of any selection made before. The guide may then save and load the settings in conjunction with the processed signal from the player, and can playback the music generated by the performance. Saving settings and other input is optional. It is further envisioned that one skilled in the art would be able to synchronize a subset of instruments that is less than or equal to all instruments.

The present invention uses a graphical cross platform programming system for music, audio and multimedia such as Max/MSP and can be used by a user in several different platforms, for example, one being a stand alone platform in which any computer may have access to, and another being a program in which the user can make updates and changes to the program, thereby creating a customized version of their own performance system.

### General Data Input Management

In the preferred embodiment, a subprogram within the software receives, manages, and routes the incoming sensor information (in one embodiment accelerometers with x,y,z axes are used for each of four sensor inputs). This program allows the end-user to effectively modify the sensitivity of the sensor by scaling the input data (for example, integer values of between 0-127) to new ranges of numbers that are then sent out to various other subprograms. This allows for the software to be adjustable to the physical strength and ability level of each of its users. Here's an example with the use of accelerometer sensors:

Each accelerometer inputs data to the software regarding its x, y, and z axis. Based on the speed of sensed movement along a given axis, a number from 0 to 127 is generated and sent to the software (0 being no acceleration, 127 being full acceleration). This software is designed to be meaningfully responsive to all ages of people, and to all ranges of cognitive and physical abilities (with a specific focus on effective design for children with severe physical disabilities). If a child of age 4 is to use the sensor-software interface, the software must be capable of scaling this incoming sensor data in a context-sensitive way. The child's fastest and slowest movements will most certainly not be the same as that of an adult human. The above-mentioned subprogram allows the user (or anyone else using the software) to readjust the particular users maximum and minimum sensor input value (ex. 0-50) to be sent to other software subprograms within the range that they expect (0-127).

### Gliding Tone Instrument:

In the preferred embodiment, a subprogram within the software receives scaled sensor(s) input data and uses it to generate different kinds of synthesized audio waveforms that glissando up and down according the interpreted incoming data. Within this subprogram, an upper threshold can be set for incoming data. When the data meets or exceeds the threshold, the program takes two actions: 1. begins counting the amount of time that passes until the threshold is met or exceeded again; 2. Based on this first action, the program will determine a pitch (frequency in Hertz) to sustain and the speed with which it will enact a glissando between this pitch and the previous sounding pitch (the program loads with a default pitch to begin with). If the time interval between met or exceeded thresholds is short (i.e. 50 msecs) the glissando will be fast, and the goal pitch to which the glissando moves will be relatively far from the pitch at the beginning of the glissando (i.e. the pitch interval will be large—two octaves up or down for example). If the time interval between met or exceeded threshold is long (i.e. 1500 msecs) the glissando will be slow, and the goal pitch to which the glissando moves will be relatively close to the pitch at the beginning of the glissando (i.e. the pitch interval will be small—a major second up or down for example). The general way in which the subprogram determines “fast” and “slow” intervals of time is directly affected by a global tempo setting in another area of the program.

A simpler explanation of the above:

When a user shakes the input sensor slowly and calmly the resulting pitches fluctuate slowly with gradual glissandi between each note. If a user shakes the input sensor quickly or violently the resulting pitches fluctuate wildly with fast glissandi in between each note—more sonic chaos to reflect the physical chaos being inflicted on the sensor.

As mentioned above, the subprogram generates different types of audio waveforms. One embodiment of the program will allow the user to select from four choices:

1. a pure sine wave that gravitates, in its glissandi, towards the 1st and 5th scale degrees of the global key (set in another area of the program). This sounds somewhat tonal.
2. a distorted square wave that gravitates, in its glissandi, towards the 1st and 5th scale degrees of the global key (set in another area of the program). This sounds somewhat tonal.
3. a pure sine wave that gravitates, in its glissandi, towards random scale degrees of the global key (set in another area of the program). This sounds chromatic.
4. a distorted square wave that gravitates, in its glissandi, towards random scale degrees of the global key (set in another area of the program). This sounds chromatic.

### Groove Files Instrument:

In the preferred embodiment, a subprogram within the software receives scaled sensor(s) input data and uses it to trigger the playback of various rhythmic soundfiles. Before playing the instrument/program the user selects from a dropdown menu containing various soundfiles—each file containing information about its tempo (bpm). This tempo information, by default, is used as the global tempo by which all other instruments are controlled. This mode of global tempo-sync can be turned off in another area of the program, so that the other instruments do not “measure” time relative to the Groove File Instrument, but instead measure time relative to a tempo set within another area of the program. Within this subprogram, two thresholds can be set for incoming data that affect the playback behavior of the soundfile. These can be described as follows:

1. Restart Sensitivity Threshold: One threshold sets the minimum scaled sensor input value necessary in order to begin or restart the user-selected soundfile.

2. Looping Sensitivity Threshold: The other threshold sets the minimum scaled sensor input value necessary in order for the selected soundfile, once begun, to loop. If this is not continuously met, the soundfile will stop playback after “one beat”—a period of time generated relative to the current tempo setting.

A Simpler Explanation of the Above: (for a User with High Functioning Motor Skills)

The user sets the Restart Sensitivity Threshold to a high value so that he/she must shake the sensor relatively vigorously in order to restart the soundfile. The user sets the Looping Sensitivity Threshold to a low value so that he/she need only slightly move the sensor in order to keep the soundfile looping. If the user stops moving for a short period of time (equal to the program's current definition of “one beat”) the soundfile correspondingly stops playback.

### Rhythm Grid Instrument:

In the preferred embodiment, a subprogram within the software receives scaled sensor(s) input data and uses it to trigger percussive rhythmic phrases of the user's design. Before playing the instrument/program the user selects from a dropdown menu containing the full range of general MIDI percussion instruments (control values on MIDI channel 10)—which will determine the sound-type triggered by the user's human-sensor interactions. The user also clicks on various boxes displayed in a grid pattern within the graphic user interface (GUI) (one embodiment design being a grid containing two rows of eight boxes each). The grid pattern represents a series of beat groupings that will affect the timing of the triggered MIDI events. The rate at which the program will move through these beat groupings (i.e. tempo) can be can set globally from another area of the program, or can be set by the Groove File instrument. When the instrument is played by the user, the percussive sound will correspond to the user's specification. (As the instrument scrubs through the beat groupings, only beats/boxes chosen by the user will produce sound—all other beats/boxes will remain silent—resulting in a unique rhythmic phrase.) Within this subprogram, two thresholds can be set for incoming data that affect the playback behavior of the Rhythm Grid. These can be described as follows:

1. Restart Sensitivity Threshold: One threshold sets the minimum scaled sensor input value necessary in order to begin or restart the user-selected beat pattern.

2. Looping Sensitivity Threshold: The other threshold sets the minimum scaled sensor input value necessary in order for the selected beat pattern, once begun, to loop. If this is not continuously met, the beat pattern will stop playback after “one beat”—a period of time generated relative to the current tempo setting.

One embodiment of this instrument contains an additional threshold set relative to the global tempo setting. When the incoming data meets or exceeds this threshold, the program takes two actions: 1. Begins counting the amount of time that passes until the threshold is met or exceeded again; 2. Based on the first action, the program will determine a level of unpredictability to be imposed on the Rhythm Grid's sound output. If the time interval between met or exceeded thresholds is short (i.e. 50 msecs) the level of unpredictability will be high (i.e. the user's specified rhythmic pattern will change to a greater degree—certain chosen beats/boxes will remain silent, other unchosen beats/boxes will randomly sound). If the time interval between met or exceeded thresholds is long (i.e. 1500 msecs) the level of unpredictability will be low (i.e. the user's specified rhythmic pattern will change to a lesser degree—the resulting rhythmic pattern will closely or exactly reflect the user's original pattern). The general way in which the subprogram determines “fast” and “slow” intervals of time is directly affected by a global tempo setting in another area of the program.

### Melody Instrument:

In the preferred embodiment, a subprogram within the software receives scaled sensor(s) input data and uses it to trigger melodic phrases generated by the full range of general MIDI instruments (excluding instruments on channel 10). Before playing the instrument/program the user selects from a dropdown menu containing the full range of general MIDI instruments—which will determine the sound-type triggered by the user's human-sensor interactions. Within this subprogram, an upper threshold can be set for incoming data. When the data meets or exceeds the threshold, the program takes two actions: 1. Chooses a MIDI pitch value (0-127) to play; 2. Triggers the playback of that pitch, also modifying the instrument's GUI. The palette of possible pitches, along with the range and tonal center of the pitch group, can be determined in another area of the program.

A simpler explanation of the above:

The user selects a tonal center and pitch grouping in a global control panel of the program. The tonal center can be any note in the MIDI range of 0-127. Among other possibilities, the user can select pitch groupings of the following: Major scale pattern, minor scale pattern, anhemitonic (pentatonic) scale pattern, chromatic, whole-tone, octatonic, arpeggiated triads, etc. Within the Melody Instrument GUI, the user selects a MIDI instrument from the dropdown menu. When the user shakes the sensor hard enough or fast enough to meet or cross the subprogram's sensitivity threshold, a pitch is sounded within parameters set in the global control panel of the program.

It is contemplated that this system can be offered in two versions. The standard version would contain all software and components necessary to use the program or to install the software on any host computer, regardless of operating system or whether or not the user owns Max/MSP, or a similar program. The expert version would require the user to also have Max/MSP, or similar program, installed on the host computer. The expert version would contain a feature allowing the user to create custom device features or to re-write any aspects of the program. It is envisioned that advanced users will be able to interact and share custom features (“patches”) via an open-source model comparable to the one created by users of the Linux operating system or other open-source applications.

It is also contemplated that both the standard version and the expert version can be incorporated into a stand-alone unit so that the system can be used without being installed on a host computer.

It is contemplated that this system will include an optional metronome light that will illuminate the tempo chosen by the user or player(s) indicated in the global control panel.

It is contemplated that this invention will include a melody writer through which the user may design unique melodies. In other words, the user wouldn't merely “adjust” the modality but rather define it, by choosing exactly the sequence, length, and volume of pitches to create a unique and original melody for the melody instrument to play when the sensor is activated.

In addition, it is contemplated that this invention will include a scale creator through which the user may pick out any group of notes on the keyboard (either a graphic of a piano keyboard on the screen, or even the computer keyboard) to create their own scales for the Melody instrument to use. Examples include, but are not limited to, individual intervals such as fourths, sevenths, etc. for ear training, 12 notes for twelve-tone scale, microtonal steps and much more.

### Other Examples/Methods of Use

1) Special education class for cognitively challenged students.
2) Special education class for physically challenged students.
3) Physical therapy for physically challenged individual or one recovering from an injury or illness.
4) Music training.
5) Performance by amateur musicians.
6) Performance by professional musicians.
7) Speech therapy.
8) Movement therapy, especially motivating a partially disabled child to move more.
9) Sensory Integration therapy (e.g., getting an autistic child to communicate with or react to outside parties by training him/her not to shun outside stimuli but to engage such stimuli).
10) Relaxation therapy.
11) Massage therapy (output goes to massage chair).
12) Laser light show (output is visual, light show).
13) Show of varying visual projections (such as a series of photos, movie clips cued to music, especially to back up performance of singers, DJs, dancers, actors, etc.).
14) Water show (like Bellagio fountains in Las Vegas).
15) Monitor performance of machines on production line.
16) Monitor actions of robot for industrial use.
17) Individual or family entertainment—put on pet, child, toy, family members.
18) Accompaniment to acrobatic performance.
19) Accompaniment to gymnastic performance.
20) Accompaniment to dance performance.
21) Accompaniment to theater performance.
22) Accompaniment to physical workout routines (aerobics, yoga, gyro kinesis, gyro tonics, pillates, etc.).
23) Accompaniment to animal show.
24) Monitor actions of robot used for home use (vacuuming, pool cleaning).
25) Monitor actions of child.
26) Help someone develop motor skills.
27) Rehearsal for musical performance.
28) Music practice.
29) Dance practice.
30) Acting practice.
31) Comedy sound effects or comedy routine.
32) Provide music to play by—attach to bicycle wheel or bicycle (tricycle, unicycle, etc.), attach to kite, attach to ball, attach to bean bag, etc.
33) Provide live entertainment at bar or similar establishment.
34) Develop new style of modern art where output results in motions that move paint brushes, pencils, paint spray nozzles, etc.
35) Storm warning (based on air speed).
36) Earthquake monitor—gives auditory signal when needle on graph moves beyond a certain threshold.
37) Music recreation.
Exemplary GUI and showing initial view for preliminary set-up and showing that the name of a player, or other designation, may be entered.

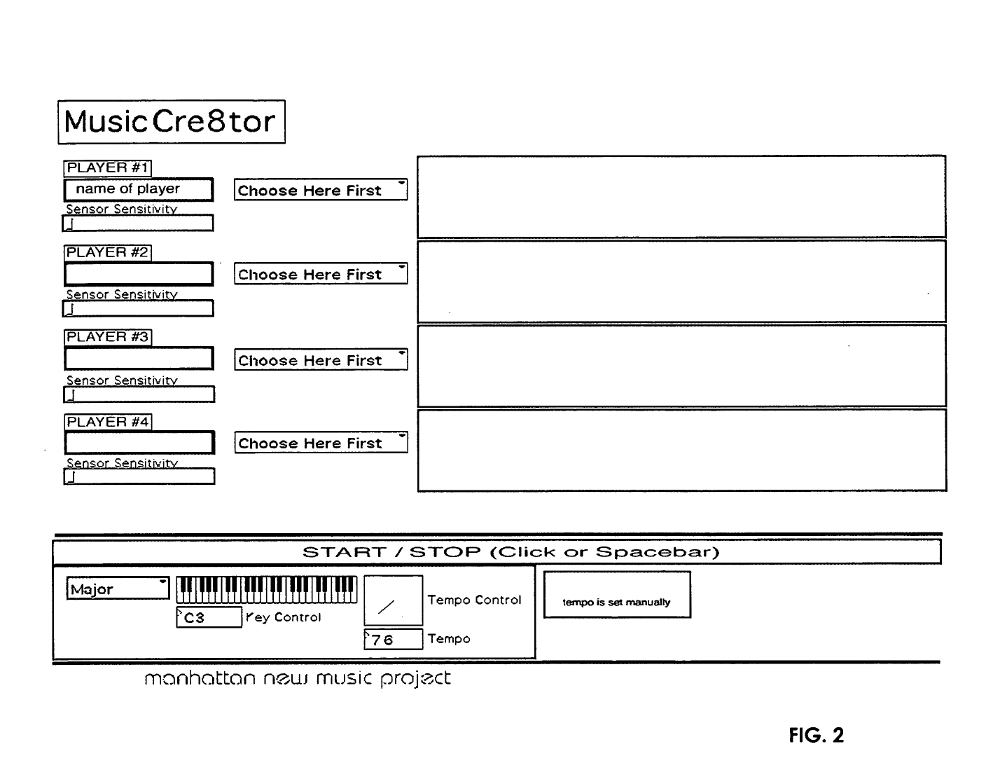

FIG. 2 is a screen shot of an exemplary first embodiment of the GUI. A name or other designation may be entered for the player by placing the mouse cursor in the empty space, clicking on the mouse, and typing the name or designation on the keyboard of the computer.

This figure is explanatory of an exemplary structure of a data processing and signal scaling system employed in the first embodiment of the present invention. In the first embodiment, a one who enters data to establish parameters in the system (a “guide”) will designate a category of instruments—either rhythm or melody. Depending on the category of instruments selected, the guide will then select an instrument—rhythm grid, groove file, MIDI melody, or gliding tone, and then a timbre. One in the art could modify the present invention to vary the selection scheme, expand upon the categories of instruments, the instruments and/or the timbres of instruments. The choice of categories, instruments and timbres includes, but is not limited to, the types specified. The guide's selections are relayed to the GUI.

The guide may perform a global save to save settings for all players with profiles in the system at the time the save option is selected. In other embodiments, the settings for each player may be saved individually and recalled for future use, so that settings for players who did not play together initially may be queued to play together later, or so that settings for one player may be substituted for those of another.

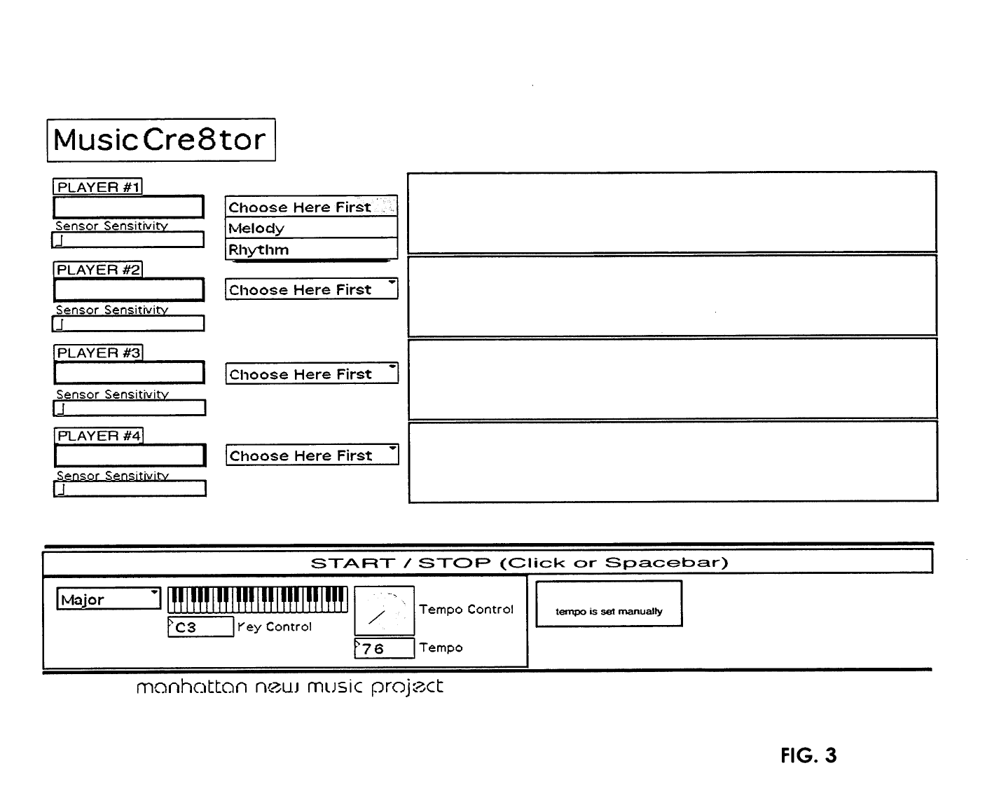

FIG. 3 is a screen shot of an exemplary first embodiment of the GUI showing that either the melody or rhythm category of instruments may be selected. It is understood that other instruments and categories of instruments may be added or substituted.

### Explanation of Data Flow for Melody Category of Instruments

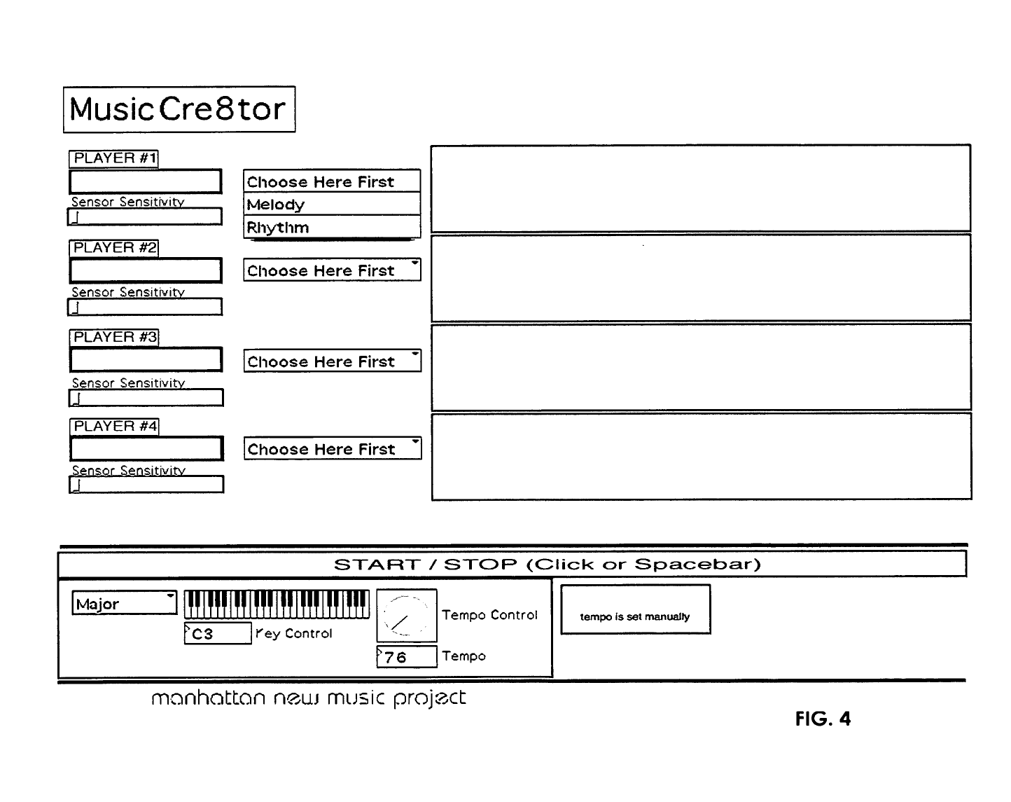

FIG. 4 is a screen shot of an exemplary first embodiment of the GUI showing selection of a melody category of instruments.

This screen shot is explanatory of a sound selection system employed in the first embodiment of the present invention. If a guide designates the melody category of instrument, then the guide has the option of designating either a MIDI melody instrument or a gliding tone instrument.

If the MIDI melody instrument is selected, first the guide designates the specific timbre the player is going to use. The guide may also modify, in any order, the scale type, the tonic note and the tempo setting.

If the gliding tone instrument is selected, the guide first designates the specific timbre the player is to use. The guide may also designate, in any order, the tonic note and the tempo setting.

The guide may save the settings. The data provided by these selections is provided to the instrument subprogram. Data from other sources is also provided to the instrument subprogam—volume may be adjusted, scaled sensor data is supplied—either directly or as modified by the sensitivity threshold. In addition, sensor data generated by the player's actions may be recorded for playback, as may the sounds generated in response to the sensor data. The instrument subprogram processes the varied data and sends a signal to the computer's digital to analogue converter (“DAC”). Once converted, the signal is sent to the sound emitting system(s).

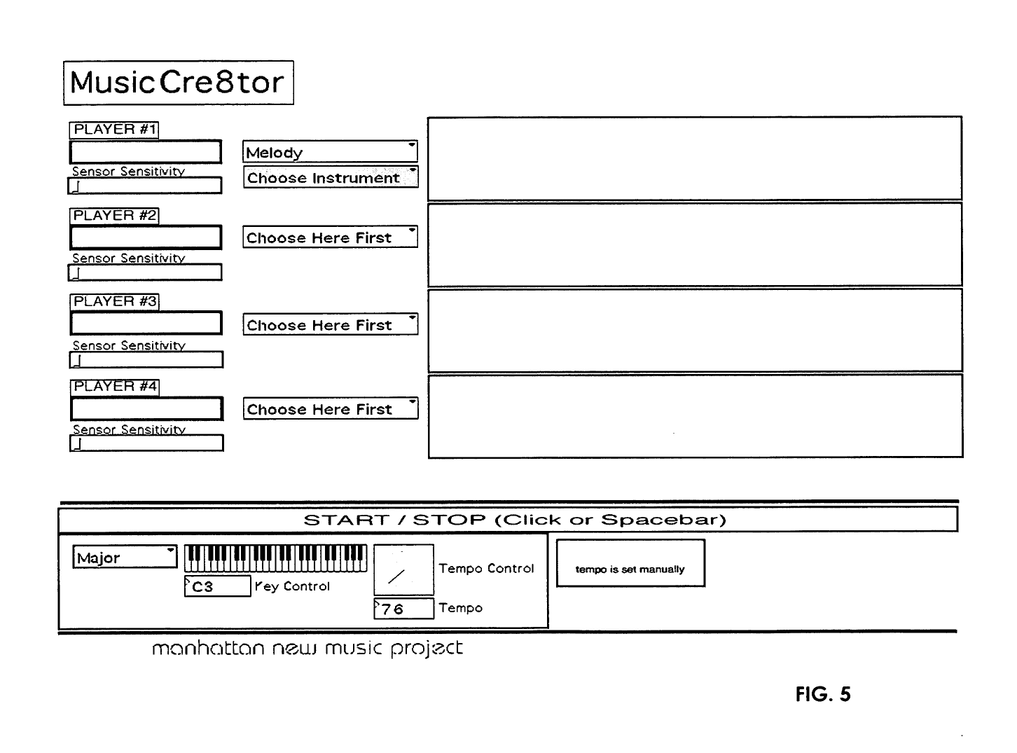

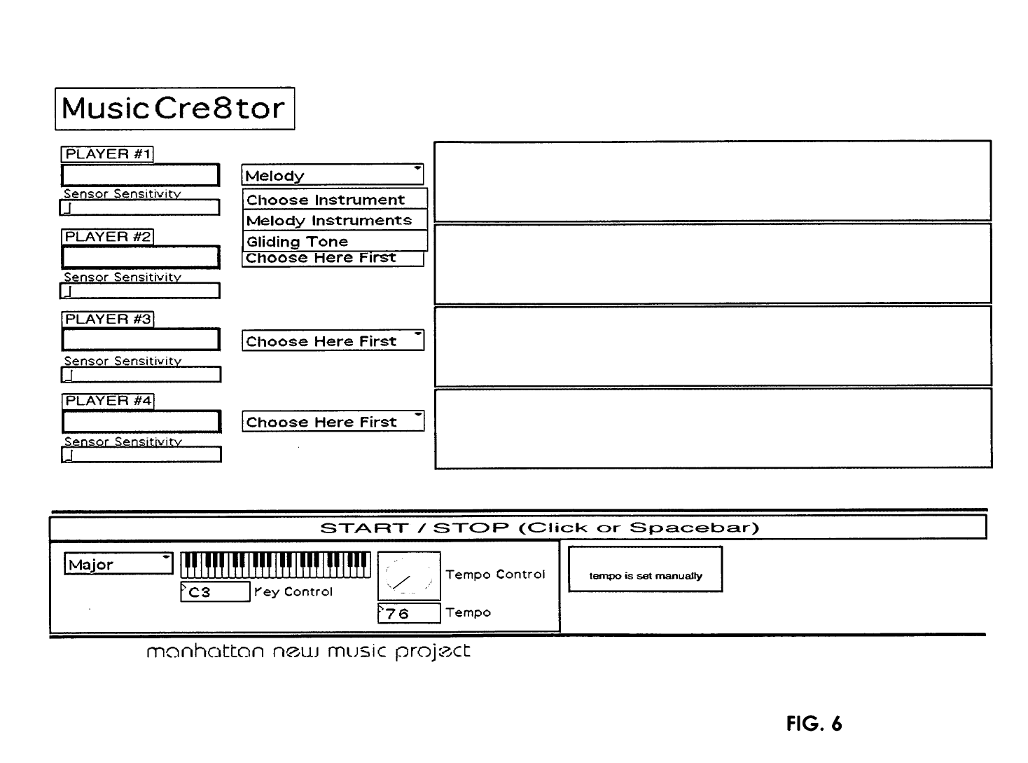

FIG. 5 is a screen shot of an exemplary first embodiment of the GUI showing that once a category of instruments has been selected, the instrument may be selected. When the “choose instruments” button is selected, the instrument choices appear—as seen in FIG. 6.

FIG. 6 is a screen shot of an exemplary first embodiment of the GUI showing that once the melody category of instruments has been selected, either melody instruments or gliding tone instruments may be selected.

### Explanation of Data Flow for MIDI Melody Instruments

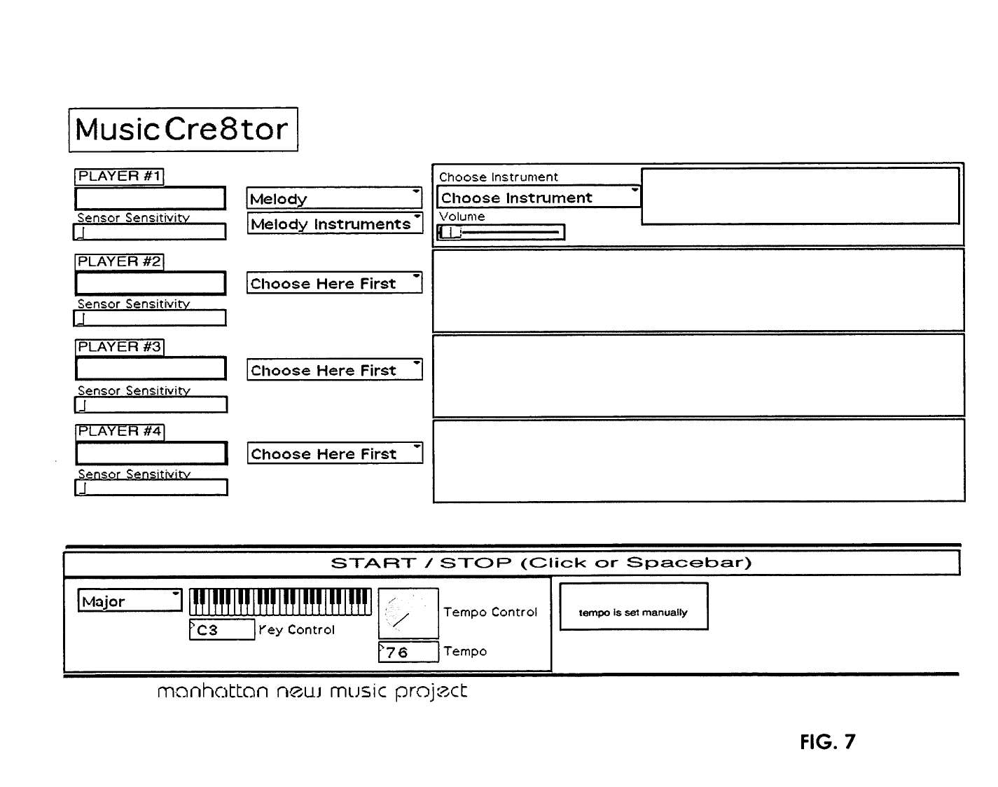

FIG. 7 is a screen shot of an exemplary first embodiment of the GUI showing that when a melody instrument is selected, the option to select the specific instrument (timbre) becomes available.

The guide may designate the specific timbre the player is going to use. The guide may adjust, in any order, the scale type, the tonic note and the tempo setting, or the guide may use the default settings for any or all of these options.

The guide may save the settings. The data provided by these selections is provided to the instrument subprogram. Data from other sources is also provided to the instrument subprogram—volume may be adjusted, scaled sensor data is supplied—either directly or as modified by the sensitivity threshold. In addition, the sounds generated by the player's actions may be recorded in real time for playback at a later time. The instrument subprogram processes the varied data and sends a signal to the digital to analogue converter. Once converted, the signal is sent to the sound emitting system(s).

Melody Instrument:

In the preferred embodiment, a subprogram within the software receives scaled sensor(s) input data and uses it to trigger melodic phrases generated by the full range of general MIDI instruments (excluding instruments on channel 10). Before playing the instrument/program the user selects from a dropdown menu containing the full range of general MIDI instruments—which will determine the sound-type triggered by the user's human-sensor interactions. Within this subprogram, an upper threshold can be set for incoming data. When the data meets or exceeds the threshold, the program takes two actions: 1. Chooses a MIDI pitch value (0-127) to play; 2. Triggers the playback of that pitch, also modifying the instrument's GUI (see figure). The palette of possible pitches, along with the range and tonal center of the pitch group, can be determined in another area of the program.

A simpler explanation of the above:

The user selects a tonal center and pitch grouping in a global control panel of the program. The tonal center can be any note in the MIDI range of 0-127. Among other possibilities, the user can select pitch groupings of the following: Major scale pattern, minor scale pattern, anhemitonic (pentatonic) scale pattern, chromatic, whole-tone, octatonic, arpeggiated triads, etc. Within the Melody Instrument GUI, the user selects a MIDI instrument from the dropdown menu. When the user shakes the sensor hard enough or fast enough to meet or cross the subprogram's sensitivity threshold, a pitch is sounded within parameters set in the global control panel of the program.

The present invention uses Max/MSP software program and can be used by a user in several different platforms one being a stand alone platform in which any computer may have access to and another being a program in which the user may make updates and changes to the program. It is contemplated that this invention will include a melody writer in which the user may design there own unique melodies and/or a scale creator in which the user may pick out any group of notes on the keyboard to create their own scales for the Melody instrument to use. Examples include but are not limited to individual intervals such as fourths, sevenths, etc. for ear training, 12 notes for twelve-tone scale, microtonal steps and much more.

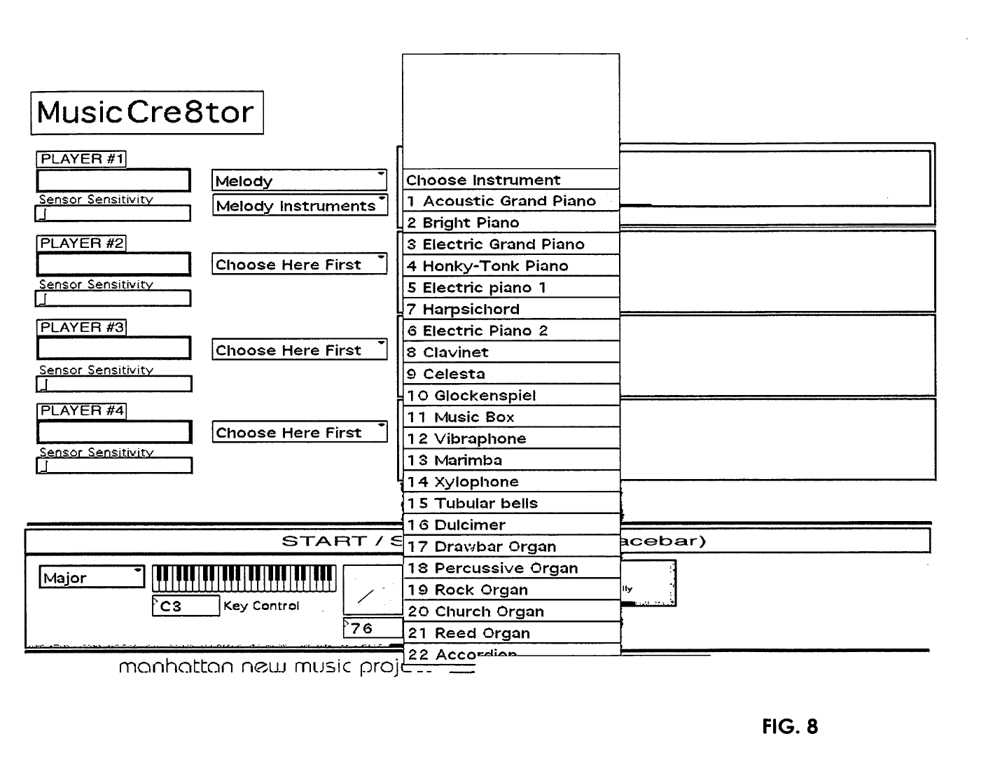

FIG. 8 is a screen shot of an exemplary first embodiment of the GUI showing a number of the 127 general MIDI melody instrument choices (timbre or characteristics), any one of which may be selected at this stage. In the example given, acoustic grand piano is selected. A MIDI expander board is available and can be attached to expand the timbre options available.

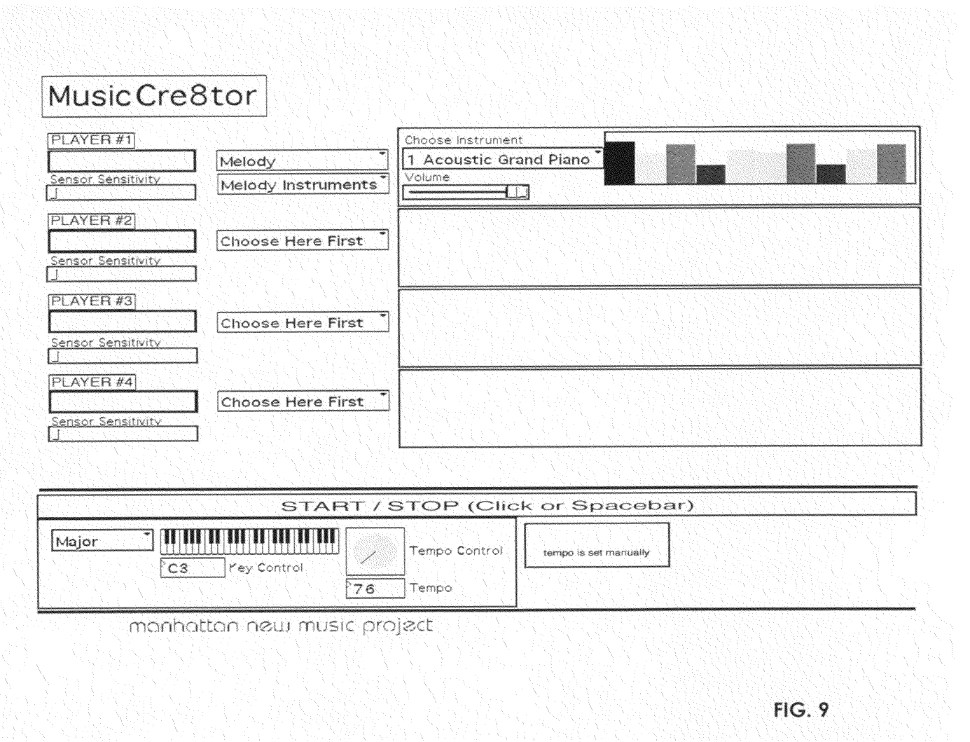

FIG. 9 is a screen shot of an exemplary first embodiment of the GUI showing the options that appear once a timbre of MIDI melody instrument has been selected. Volume may be adjusted as it could have been at any stage once the option appeared. A display appears and changes in response to signal strength. In the first embodiment, the display is of ⅛ notes or other “count,” but there is no restriction on the nature of the display that may be used. As at any later or earlier stage, sensitivity may be manually adjusted and selections on the global control panel, seen here at the bottom of the display, may be adjusted. The display is an immediate representation of the pitch, volume and rhythmic speed of the melody generated by the player.

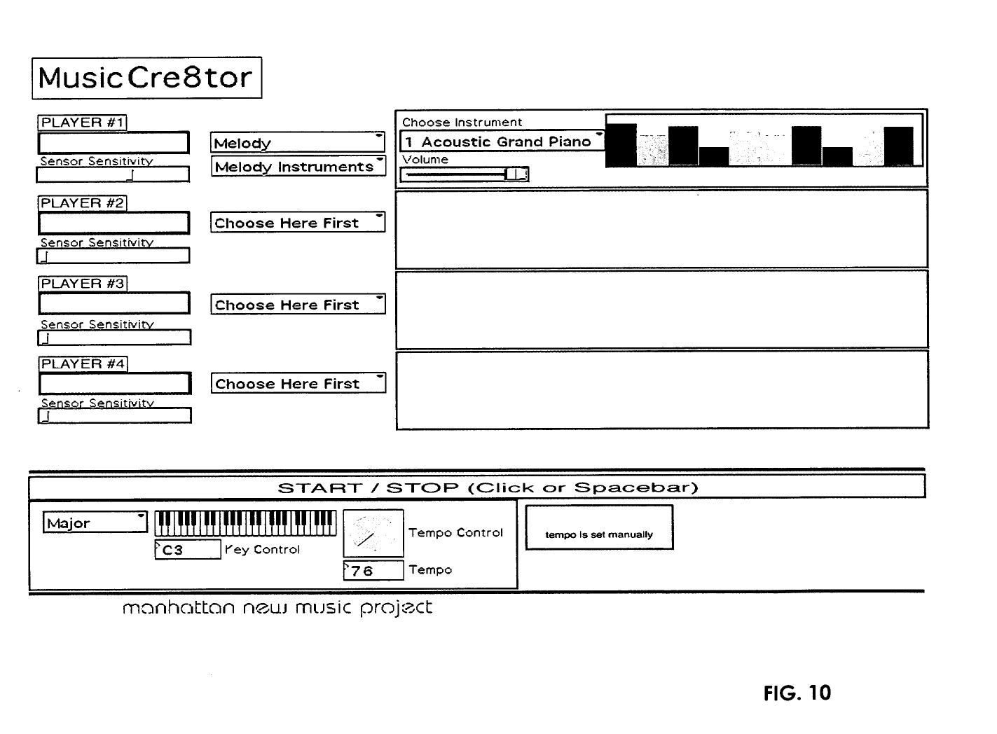

FIG. 10 is a screen shot of an exemplary first embodiment of the GUI showing adjustment of the sensor sensitivity. Adjustment and readjustment of the sensor sensitivity can be done at any time.

### General Data Input Management:

In the preferred embodiment, a subprogram within the software receives, manages, and routes the incoming sensor information (in one embodiment accelerometers with x,y,z axes are used for each of four sensor inputs). This program allows the end-user to effectively modify the sensitivity of the sensor by scaling the input data (for example, integer values of between 0-127) to new ranges of numbers that are then sent out to various other subprograms. This allows for the software to be adjustable to the physical strength and ability level of each of its users. Here's an example with the use of accelerometer sensors:

Each accelerometer inputs data to the software regarding its x, y, and z axis. Based on the speed of sensed movement along a given axis, a number from 0 to 127 is generated and sent to the software (0 being no acceleration, 127 being full acceleration). This software is designed to be meaningfully responsive to a variety of users, including to all ages of people, and to all ranges of cognitive and physical abilities (with a specific focus on effective design for children with severe physical disabilities). If a child of age 4 is to use the sensor-software interface, the software must be capable of scaling this incoming sensor data in a context-sensitive way. The child's fastest and slowest movements will most certainly not be the same as that of an adult human. The above-mentioned subprogram allows the player (or any other user working with the software) to readjust a particular player's maximum and minimum sensor input value (ex. 0-50) to be sent to other software subprograms within the range that they expect (0-127).

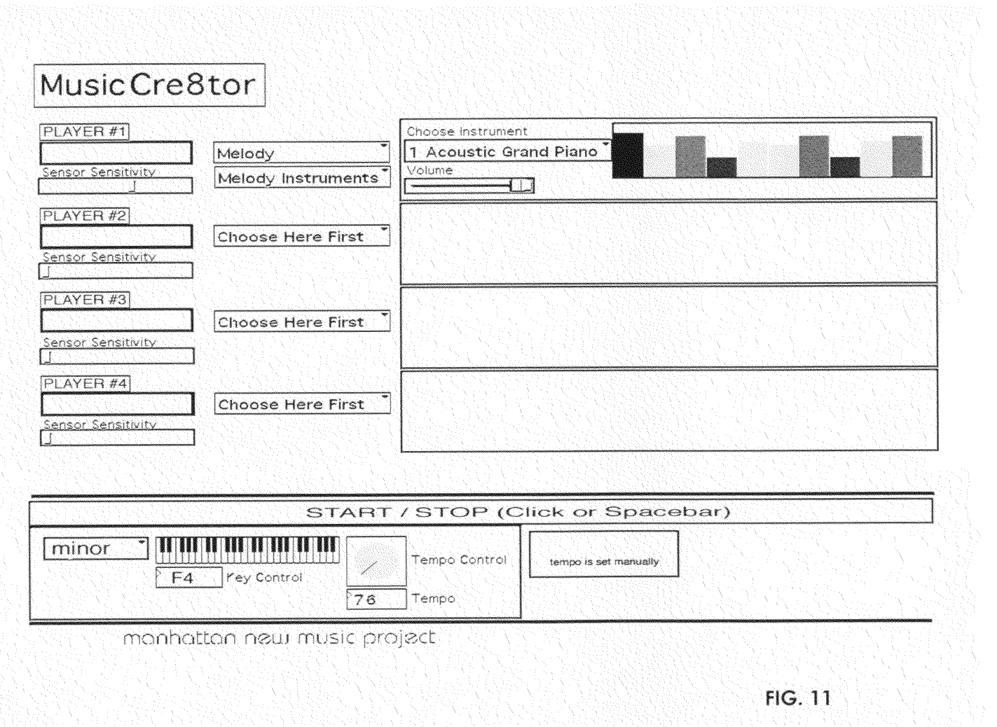

FIG. 11 is a screen shot of an exemplary first embodiment of the GUI showing adjustment of the scale (major, minor, pentatonic, et al.), tonic scale (labeled as “key control” in screen shot, with options such as C#3 and D#2), via the global control panel.

Explanation of data flow for Gliding Tone Instruments

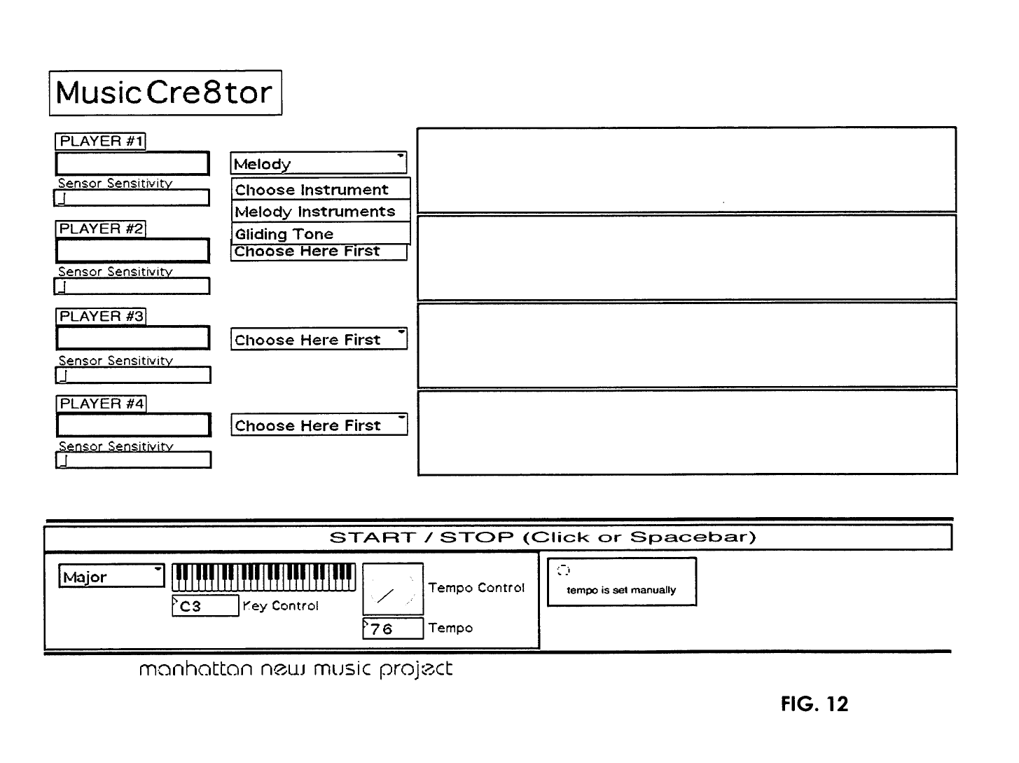

FIG. 12 is a screen shot of an exemplary first embodiment of the GUI showing selection of a melody category of instrument and a gliding tone instrument.

The guide may designate the specific timbre (i.e., waveform, including such sounds as, but not limited to sirens, sine waves and Atari waves) the player is to use, and may adjust, in any order, the tonic center and the scale.

The guide may save the settings. The data provided by these selections is provided to the instrument subprogram. Data from other sources is also provided to the instrument subprogram—volume may be adjusted, scaled sensor data is supplied—either directly or as modified by the sensitivity threshold. In addition, the sonic result of the player's actions may be recorded for playback. The instrument subprogram processes the varied data and sends a signal to the digital to analogue converter. Once converted, the signal is sent to the sound emitting system(s).

Gliding Tone Instrument:

In the preferred embodiment, a subprogram within the software receives scaled sensor(s) input data and uses it to generate different kinds of synthesized audio waveforms that glissando up and down according the interpreted incoming data. Within this subprogram, an upper threshold can be set for incoming data. When the data meets or exceeds the threshold, the program takes two actions: 1. begins counting the amount of time that passes until the threshold is met or exceeded again; 2. Based on this first action, the program will determine a pitch (frequency in Hertz) to sustain and the speed with which it will enact a glissando between this pitch and the previous sounding pitch (the program loads with a default pitch to begin with). If the time interval between met or exceeded thresholds is short (i.e. 50 msecs) the glissando will be fast, and the goal pitch to which the glissando moves will be relatively far from the pitch at the beginning of the glissando (i.e. the pitch interval will be large—two octaves up or down for example). If the time interval between met or exceeded threshold is long (i.e. 1500 msecs) the glissando will be slow, and the goal pitch to which the glissando moves will be relatively close to the pitch at the beginning of the glissando (i.e. the pitch interval will be small—a major second up or down for example). The general way in which the subprogram determines “fast” and “slow” intervals of time is directly affected by a global tempo setting in another area of the program.

A simpler explanation of the above:

When a user shakes the input sensor slowly and calmly the resulting pitches fluctuate slowly with gradual glissandi between each note. If a user shakes the input sensor quickly or violently the resulting pitches fluctuate wildly with fast glissandi in between each note—more sonic chaos to reflect the physical chaos being inflicted on the sensor.

As mentioned above, the subprogram generates different types of audio waveforms. One embodiment of the program will allow the user to select from four choices:

1. a pure sine wave that gravitates, in its glissandi, towards the 1st and 5th scale degrees of the global key (set in another area of the program). This sounds somewhat tonal.
2. a distorted square wave that gravitates, in its glissandi, towards the 1st and 5th scale degrees of the global key (set in another area of the program). This sounds somewhat tonal.
3. a pure sine wave that gravitates, in its glissandi, towards random scale degrees of the global key (set in another area of the program). This sounds chromatic.
4. a distorted square wave that gravitates, in its glissandi, towards random scale degrees of the global key (set in another area of the program). This sounds chromatic.

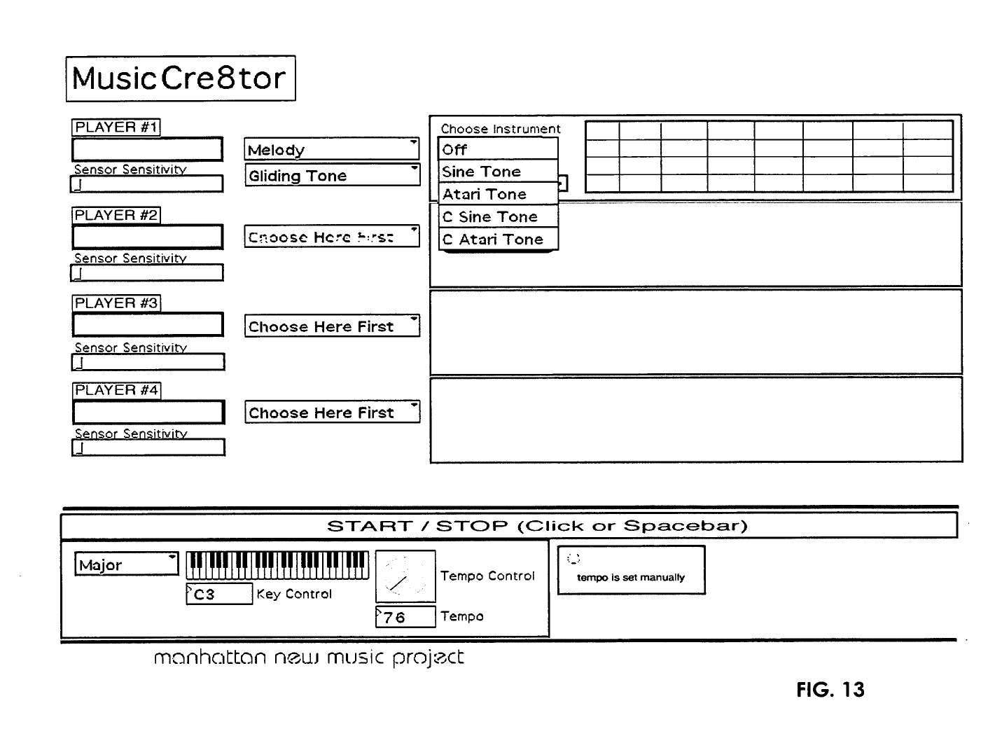

FIG. 13 is a screen shot of an exemplary first embodiment of the GUI showing options available once a gliding tone instrument has been selected. In the first embodiment, any one of four different timbres may be selected at this point. In the first embodiment, once a timbre has been selected, a display panel for a waveform also appears. It is envisioned that other embodiments may have more or different waveform and display options.

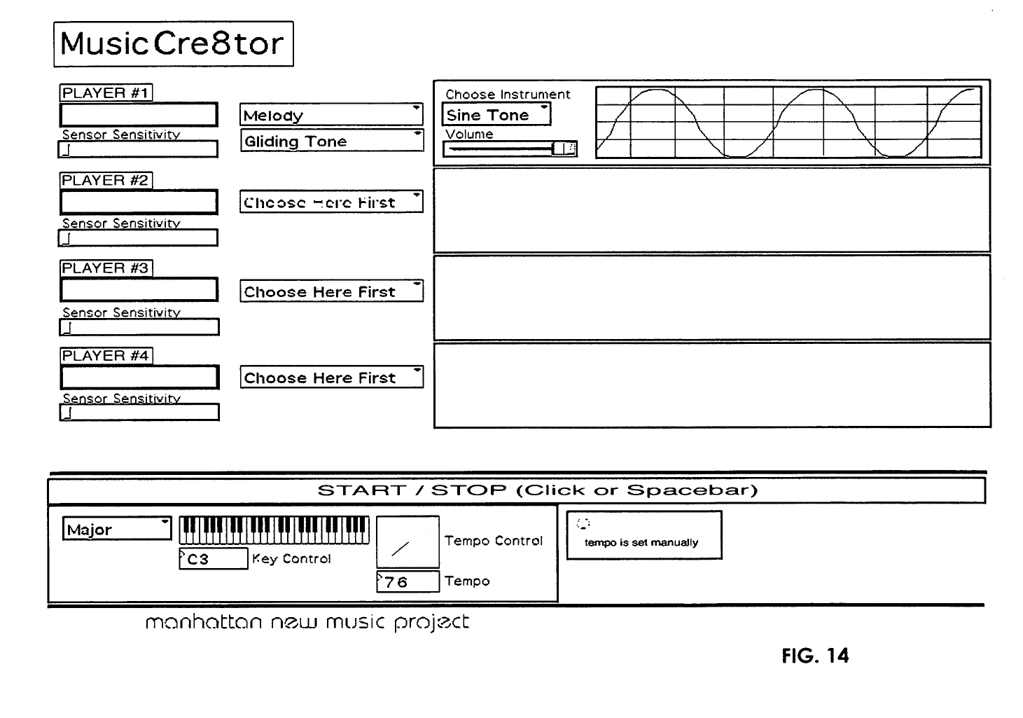

FIG. 14 is a screen shot of an exemplary first embodiment of the GUI showing selection of a sine tone timbre. In this exemplary first embodiment, volume is adjusted to maximum and a sine wave is displayed on the display panel.

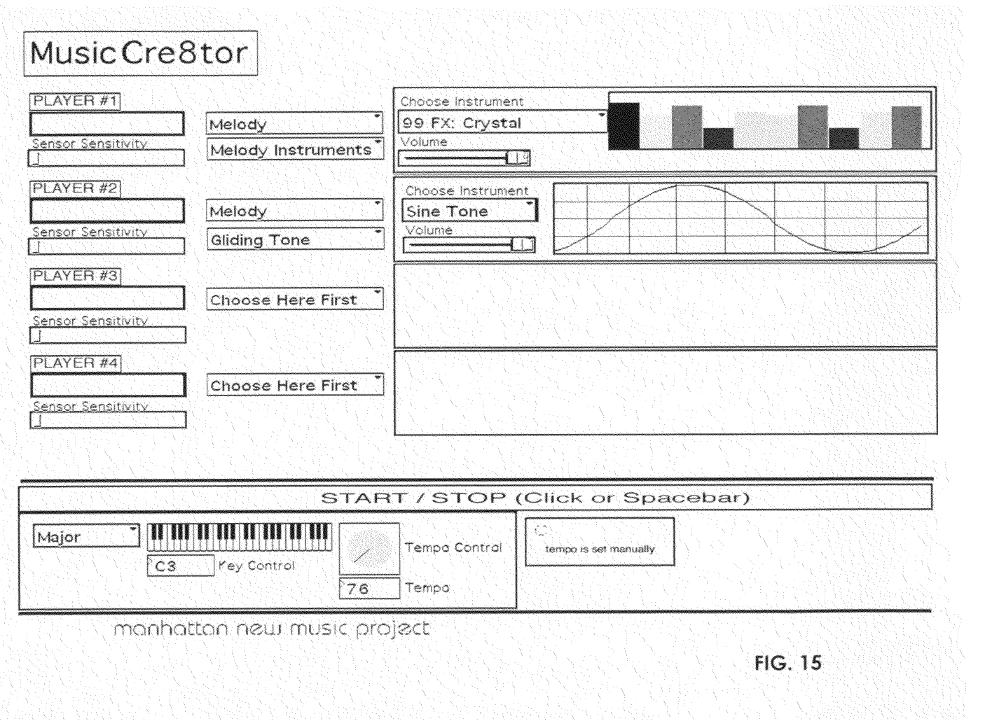

FIG. 15 is a screen shot of an exemplary first embodiment of the GUI showing an example of what the display could look like if a Fx: Crystal timbre of a MIDI melody instrument was selected for one player, and a Sine Tone timbre of a gliding tone instrument was selected for a second player.

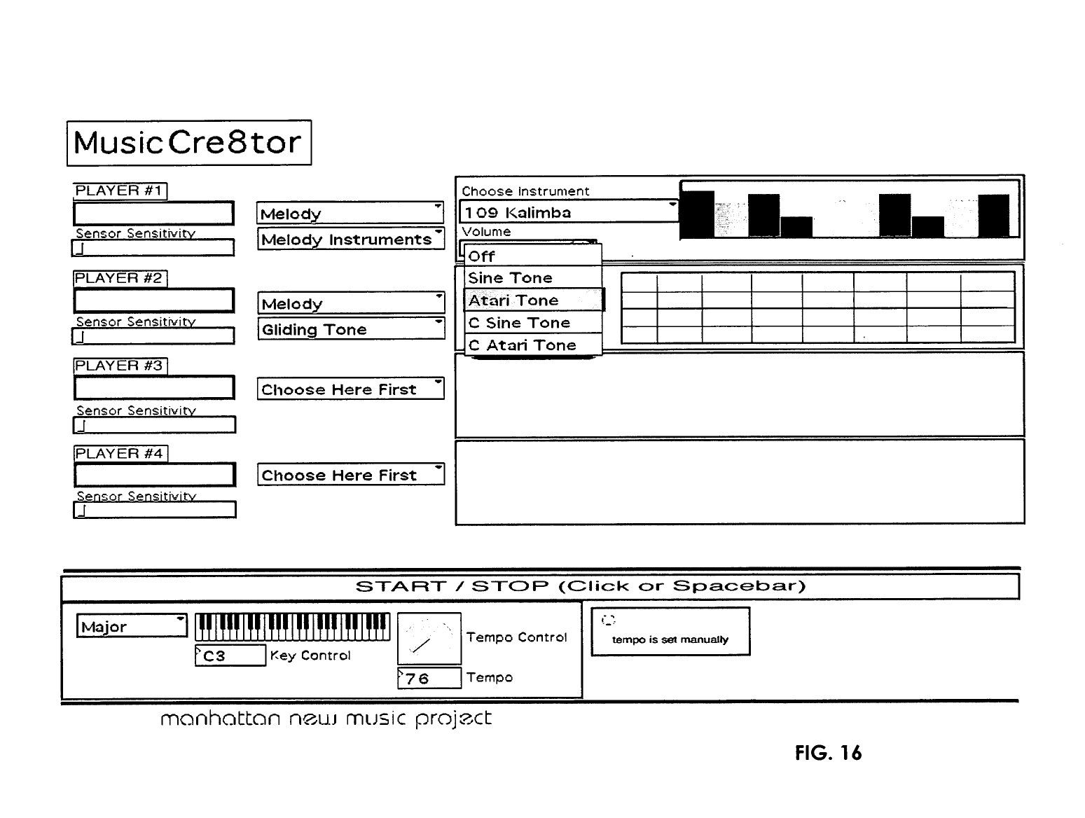

FIG. 16 is a screen shot of an exemplary first embodiment of the GUI showing selection of an Atari tone timbre choice for a MIDI melody instrument and another timbre choice for a gliding tone melody instrument.

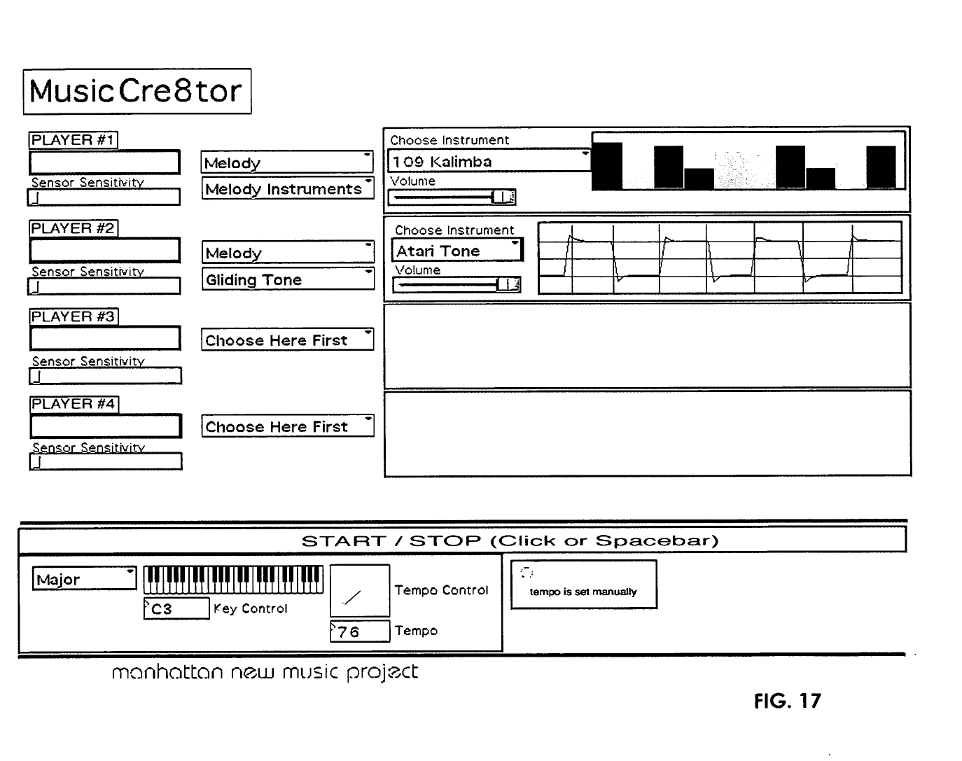

FIG. 17 is a screen shot of an exemplary first embodiment of the GUI showing how the display can change as different timbres are selected for the various MIDI melody and gliding tone instruments which reflect the pitch of each instrument as controlled by the sensors. Explanation of data flow for Rhythm category of instruments

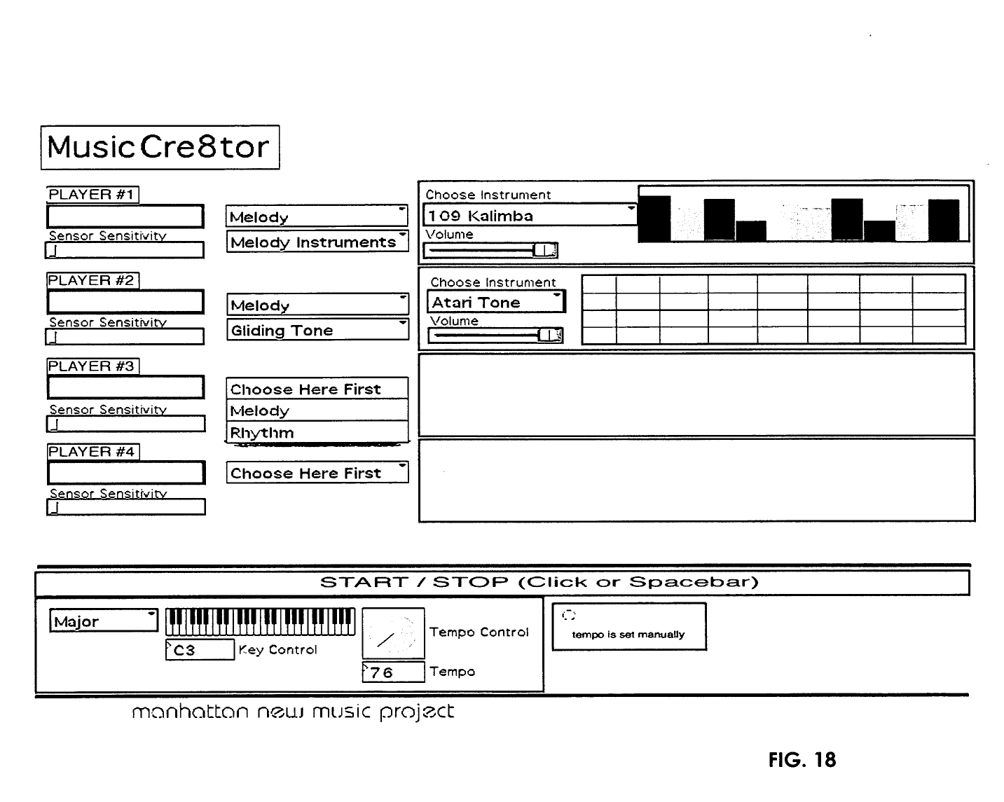

FIG. 18 is a screen shot of an exemplary first embodiment of the GUI showing selection of a rhythm category of instruments.

If a guide designates the rhythm category of instruments, the guide then has the option of selecting either a groove file instrument or a rhythmic grid instrument.

If the groove file instrument is selected, then the guide designates the groove soundfile timbre the player is going to use. The guide may adjust the sensitivity threshold and the volume. The groove file automatically sets the tempo globally for all instruments, which means that all instruments are now synchronized with the tempo of the groove file. However, there is an option to un-synchronize the groove file tempo. Un-synchronizing the instruments from the groove-file tempo is done via the global control panel/program. If this option is selected, the other instruments are still synchronized by the global control panel and the groove file operates as the independent groove file selections suggest. It is contemplated that additional options may be added so that it is possible for some instruments to be synchronized to the groove file while others are not and for those instruments to be “played” together. If more than one groove file is selected and synchronization with groove file is selected, the last chosen set of groove file options will control.

If the rhythmic grid style instrument is selected, the guide first designates the specific timbre the player is to use and then creates a rhythmic pattern by selecting and unselecting any sequence of 16th notes to be played over 4 bars. The guide may also adjust, in any order, the sensitivity threshold, the volume, and the tempo setting (if not set globally to be synchronized with the groove file). Other embodiments allow for longer and/or shorter lengths of rhythmic patterns and for the unit of the rhythmic patterns to vary from 16^{th} notes (e.g. change it to 32th notes, ⅛^{th} notes, triplets etc).

The guide may save the settings in the global control panel. The data provided by these selections is provided to the instrument subprogram. Data from other sources is also provided to the instrument subprogram—volume may be adjusted, scaled sensor data is supplied—either directly or as modified by the sensitivity threshold. The guide may also adjust restart sensitivity so that the pattern (the sequence of 16th notes played over 4 bars) will restart at the beginning if the sensor's signal exceeds a certain threshold. In addition, the signal generated by the player's actions, and the sound generated thereby, may be recorded in real time for playback at a later time. The instrument subprogram processes the varied data and sends a signal to the DAC. Once converted, the signal is sent to the sound emitting system(s).

### Explanation of Data Flow for Rhythm Grid Style of Rhythm Instruments

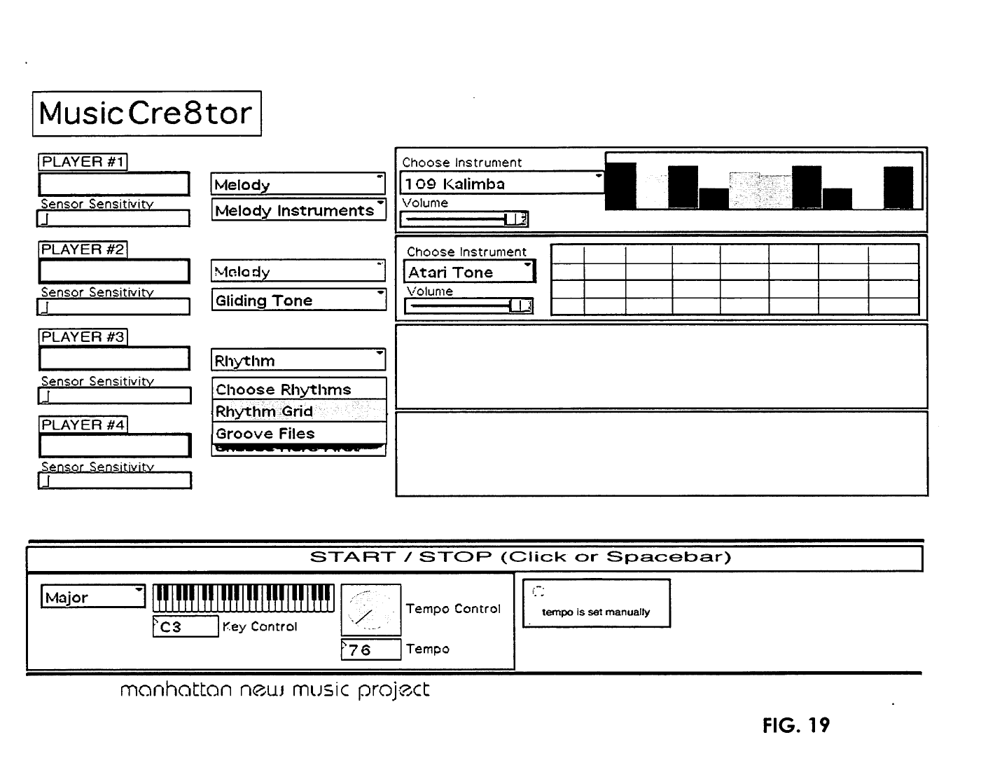

FIG. 19 is a screen shot of an exemplary first embodiment of the GUI showing selection of a rhythm grid instrument.

### Rhythm Grid Instrument:

In the preferred embodiment, a subprogram within the software receives scaled sensor(s) input data and uses it to trigger percussive rhythmic phrases of the user's design. Before playing the instrument/program the user selects from a dropdown menu containing the full range of general MIDI percussion instruments (control values on MIDI channel 10)—which will determine the sound-type triggered by the user's human-sensor interactions. The user also clicks on various boxes displayed in a grid pattern within the graphic user interface (GUI) (one embodiment design being a grid containing two rows of eight boxes each). The grid pattern represents a series of beat groupings that will affect the timing of the triggered MIDI events. The rate at which the program will move through these beat groupings (i.e. tempo) can be can set globally from another area of the program, or can be set by the Groove File instrument. When the instrument is played by the user, the percussive sound will correspond to the user's specification. (As the instrument scrubs through the beat groupings, only beats/boxes chosen by the user will produce sound—all other beats/boxes will remain silent—resulting in a unique rhythmic phrase.) Within this subprogram, two thresholds can be set for incoming data that affect the playback behavior of the Rhythm Grid. These can be described as follows:

1. Restart Sensitivity Threshold: One threshold sets the minimum scaled sensor input value necessary in order to begin or restart the user-selected beat pattern.

2. Looping Sensitivity Threshold: The other threshold sets the minimum scaled sensor input value necessary in order for the selected beat pattern, once begun, to loop. If this is not continuously met, the beat pattern will stop playback after “one beat”—a period of time generated relative to the current tempo setting.

One embodiment of this instrument contains an additional threshold set relative to the global tempo setting. When the incoming data meets or exceeds this threshold, the program takes two actions: 1. Begins counting the amount of time that passes until the threshold is met or exceeded again; 2. Based on the first action, the program will determine a level of unpredictability to be imposed on the Rhythm Grid's sound output. If the time interval between met or exceeded thresholds is short (i.e. 50 msecs) the level of unpredictability will be high (i.e. the user's specified rhythmic pattern will change to a greater degree—certain chosen beats/boxes will remain silent, other unchosen beats/boxes will randomly sound). If the time interval between met or exceeded thresholds is long (i.e. 1500 msecs) the level of unpredictability will be low (i.e. the user's specified rhythmic pattern will change to a lesser degree—the resulting rhythmic pattern will closely or exactly reflect the user's original pattern). The general way in which the subprogram determines “fast” and “slow” intervals of time is directly affected by a global tempo setting in another area of the program.

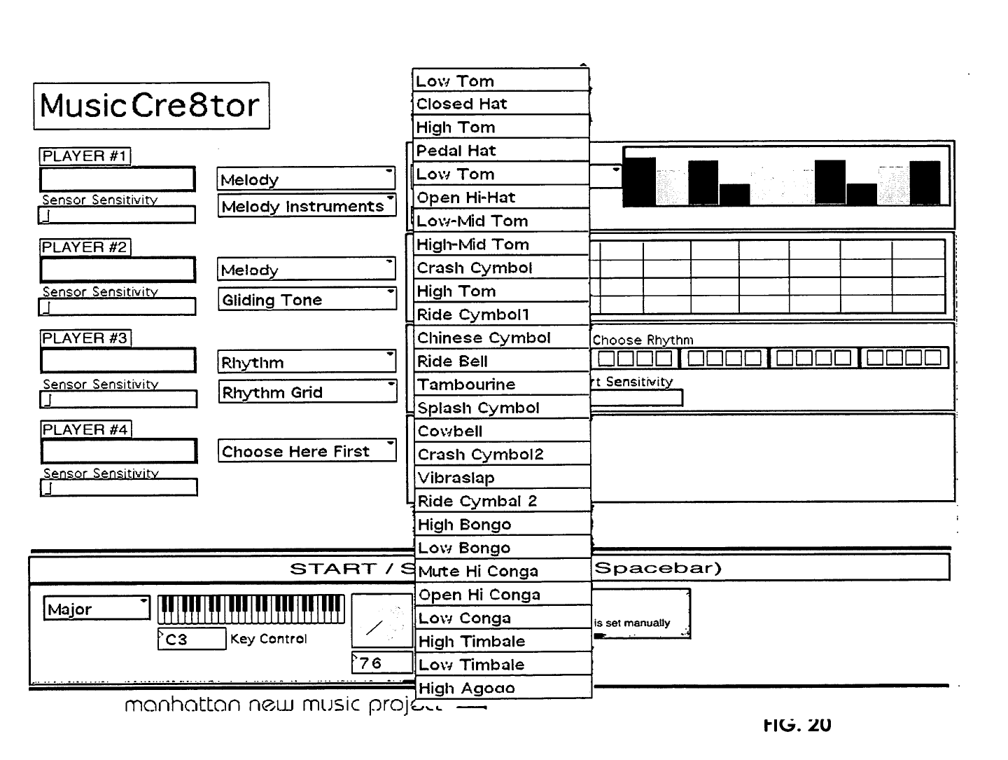

FIG. 20 is a screen shot of an exemplary first embodiment of the GUI showing all general MIDI percussion instruments (channel 10) available for the MIDI rhythm grid instrument. In this example, a high agogo timbre is selected.

The guide designates the specific MIDI or soundfile the player is to use, then designates, in any order, a rhythm pattern and the tempo setting. In this embodiment, a display showing 16 boxes is used to set the rhythm pattern. In the current preferred embodiment, these represent 16th notes played over 4 bars. The guide designates one or more of the 16 boxes. Only motion occurring during those intervals results in sound generation. It is envisioned that more or less than 16 boxes may be used, or that some representation other than a box may be used.

In addition, the guide can restart the sensitivity adjustment and/or adjust the volume. The sound generated by a player's actions, may be recorded in real time and played back later. Scaled sensor data, either directly or scaled via sensitivity threshold, is transmitted to instrument subprogram where it, along with all the data from other sources, is transmitted to the DAC. Once converted, the signal is sent to the sound emitting system(s).

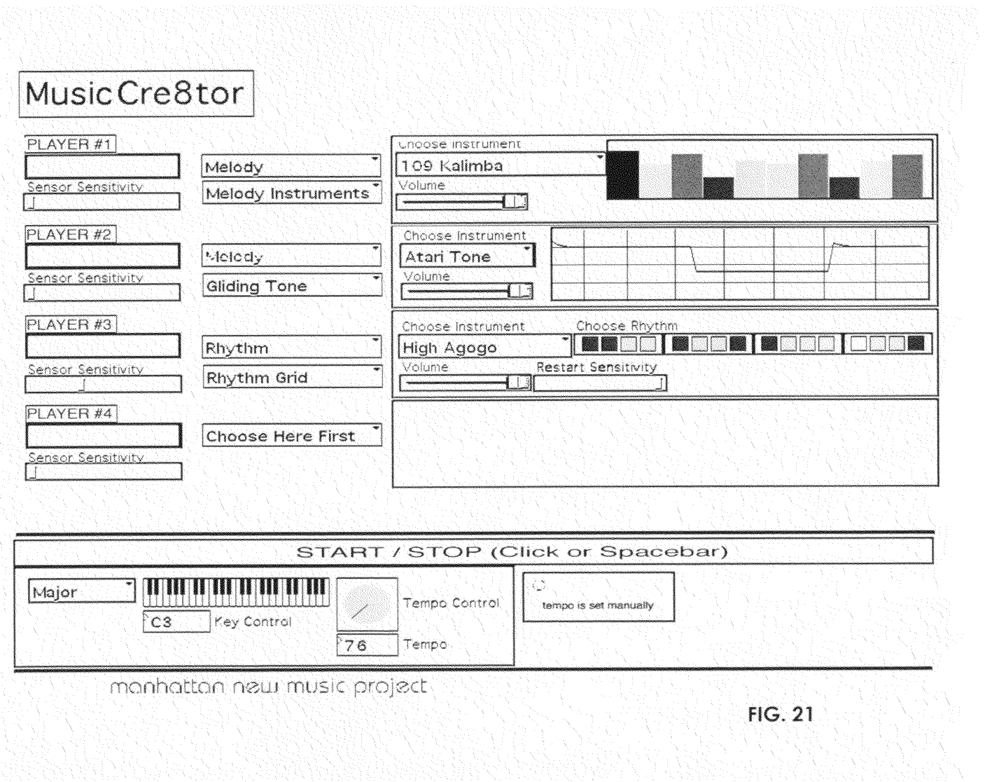

FIG. 21 is a screen shot of an exemplary first embodiment of the GUI showing an example of the display that appears when a timbre of MIDI rhythm instrument has been selected. (See display and options as shown for Player #3.) In this embodiment, sixteen (16) boxes are displayed. One or more of the boxes may be selected. As shown in the exemplary first embodiment, sound is only generated when motion coincides with a selected box. In other words, if the player is moving during at a point in the “count” where no box is selected, no sound is generated. Similarly, if the player is not moving where a box has been selected, again no sound is generated.

In the preferred embodiment, when a box is selected, it will change color. When a signal from the corresponding sensor is detected at the appropriate interval to correspond to a selected box, the box will change to a different color—and a tone is produced.

This instrument in the preferred embodiment has an additional feature of a “restart sensitivity” which can be manually adjusted. This feature allows the pattern to be restarted if the sensor receives a signal above the manually set threshold. In the example shown, if the sensor is, for example, an accelerometer, only a fairly fast motion will restart the pattern because the restart sensitivity is set near maximum.

This screen shot also shows the display that appears if an Atari tone timbre is selected.

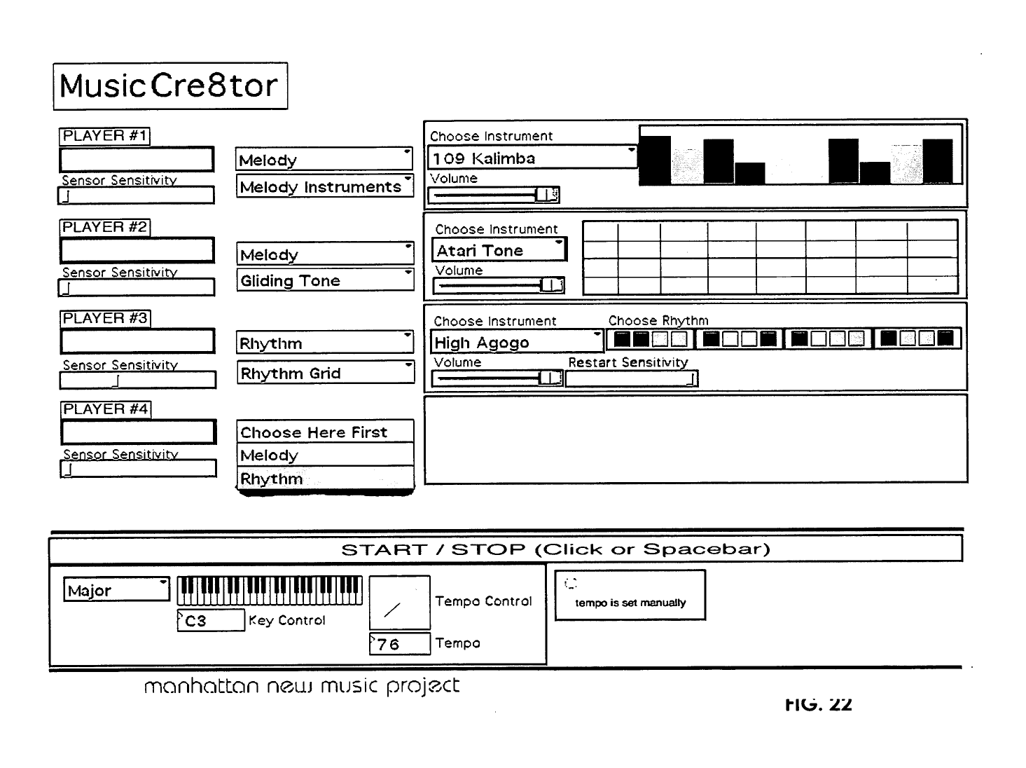

FIG. 22 is a screen shot of an exemplary first embodiment of the GUI showing selection of a rhythm category of instruments.

### Explanation of Data Flow for Groove File Style of Rhythm Instruments

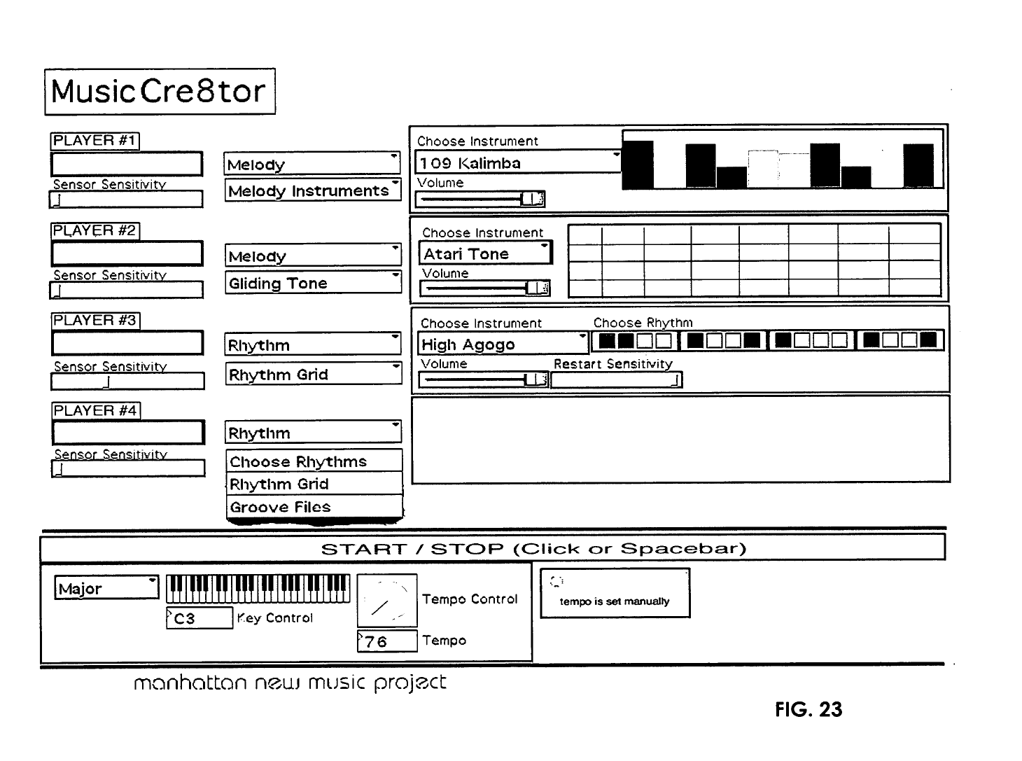

FIG. 23 is a screen shot of an exemplary first embodiment of the GUI showing selection of a groove file instrument from the rhythm category of instruments.

The guide designates the specific instrument the player is going to use and designates whether the groove file tempo will be synchronized with other instruments or not. The guide may also restart the sensitivity adjustment. These settings may be saved and the data is transmitted to the DAC.

The DAC also receives information in the form of volume adjustment and of soundfiles. In one embodiment, the scaled sensor data is sent to the DAC via a soundfile that may or may not have been scaled via the sensitivity threshold. Sensitivity may be reset and the signals generated by the player's actions, and the sounds generated therefrom, may be recorded for playback. Data from resetting the sensitivity and from the recorded signals is also transmitted to the DAC. Once converted, the signal is sent to the sound emitting system(s).

### Groove Files Instrument:

In the preferred embodiment, a subprogram within the software receives scaled sensor(s) input data and uses it to trigger the playback of various rhythmic soundfiles. Before playing the instrument/program the user selects from a dropdown menu containing various soundfiles—each file containing information about its tempo (bpm). This tempo information, by default, is used as the global tempo by which all other instruments are controlled. This mode of global tempo-sync can be turned off in another area of the program, so that the other instruments do not “measure” time relative to the Groove File Instrument, but instead measure time relative to a tempo set within another area of the program. Within this subprogram, two thresholds can be set for incoming data that affect the playback behavior of the soundfile. These can be described as follows:

1. Restart Sensitivity Threshold: One threshold sets the minimum scaled sensor input value necessary in order to begin or restart the user-selected soundfile.

2. Looping Sensitivity Threshold: The other threshold sets the minimum scaled sensor input value necessary in order for the selected soundfile, once begun, to loop. If this is not continuously met, the soundfile will stop playback after “one beat”—a period of time generated relative to the current tempo setting.

A Simpler Explanation of the Above: (for a User with High Functioning Motor Skills)

The user sets the Restart Sensitivity Threshold to a high value so that he/she must shake the sensor relatively vigorously in order to restart the soundfile. The user sets the Looping Sensitivity Threshold to a low value so that he/she need only slightly move the sensor in order to keep the soundfile looping. If the user stops moving for a short period of time (equal to the program's current definition of “one beat”) the soundfile correspondingly stops playback.

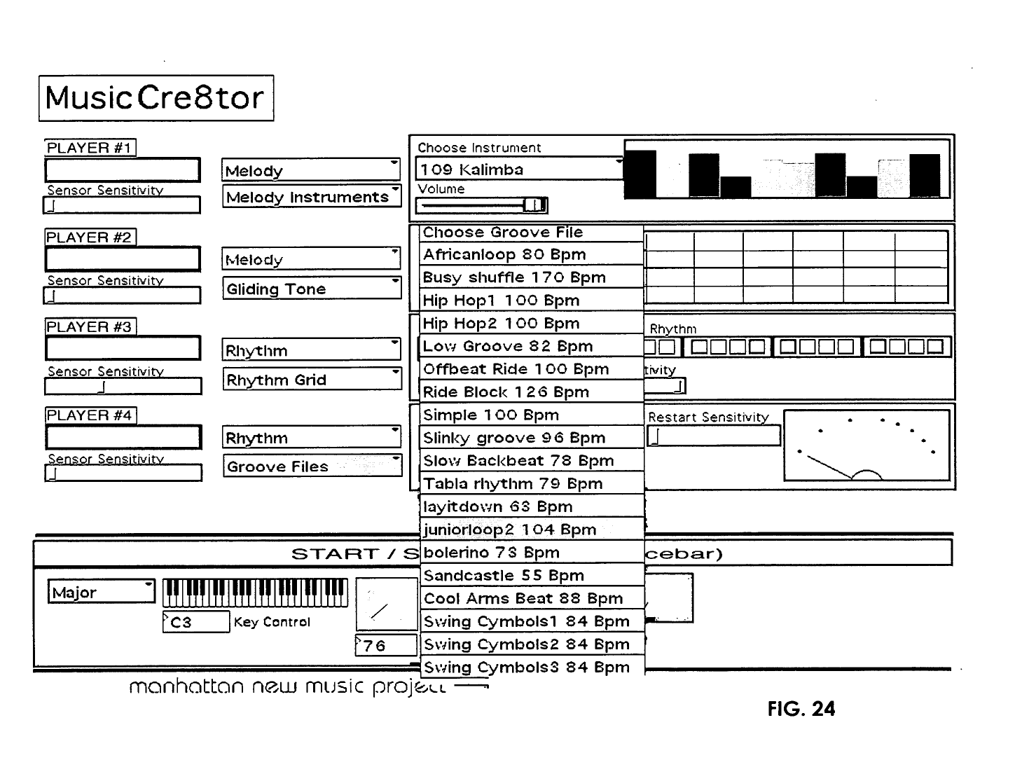

FIG. 24 is a screen shot of an exemplary first embodiment of the GUI showing several of the possible choices of timbre for the groove file instrument. In this example, a juniorloop2 104 bpm (beats per minute) is selected.

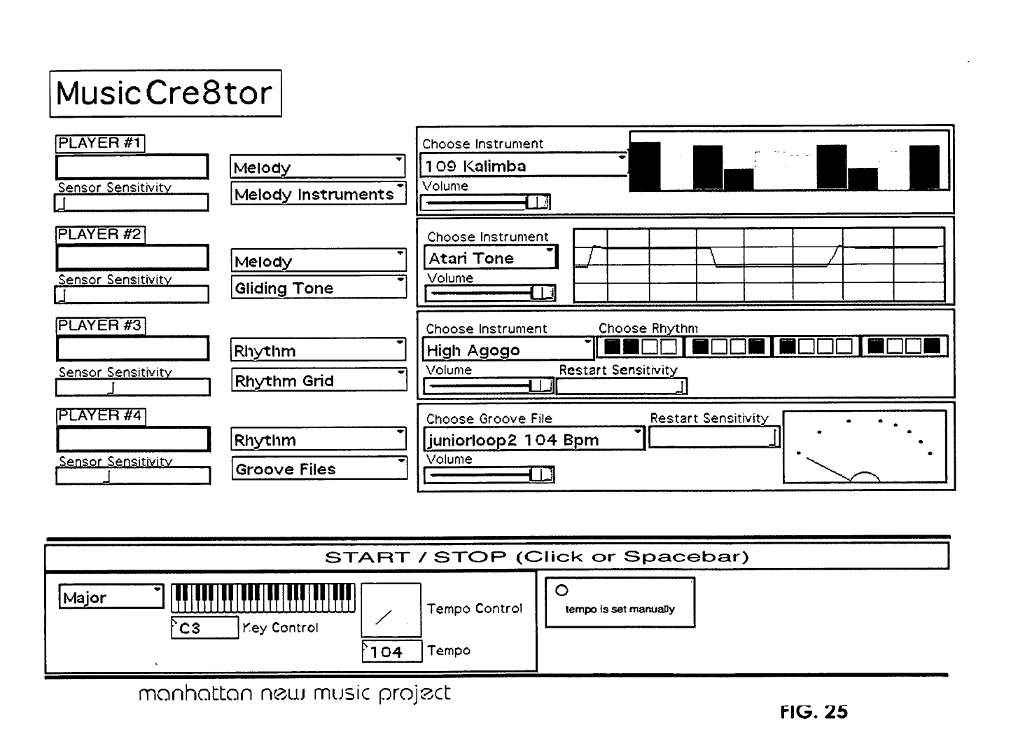

FIG. 25 is a screen shot of an exemplary first embodiment of the GUI showing one exemplary display if a groove file instrument is selected. In this example, a juniorloop2 timbre at 104 bpm is selected. As with the other rhythm instruments, a restart sensitivity option is shown, as described above in FIGS. 18 and 21. Also, a unique display feature is shown for this instrument. For each instrument there is a unique graphic image that corresponds to the volume/amplitude and the pitch/frequency. In this screen shot, the further the needle moves to the right on the meter, the greater the volume. Pitch/frequency is shown by fluctuations in the needle.

The lower portion of the screen shot shows an exemplary first embodiment of the GUI with an exemplary display of the global control panel. In this example, scale and tonic are left in the default positions (major and C3), tempo is set to 104 (per the timbre), and all instruments are synchronized with the groove file tempo because the synchronization control is set so that the tempo is set by the groove file. Synchronization with the groove file is optional.

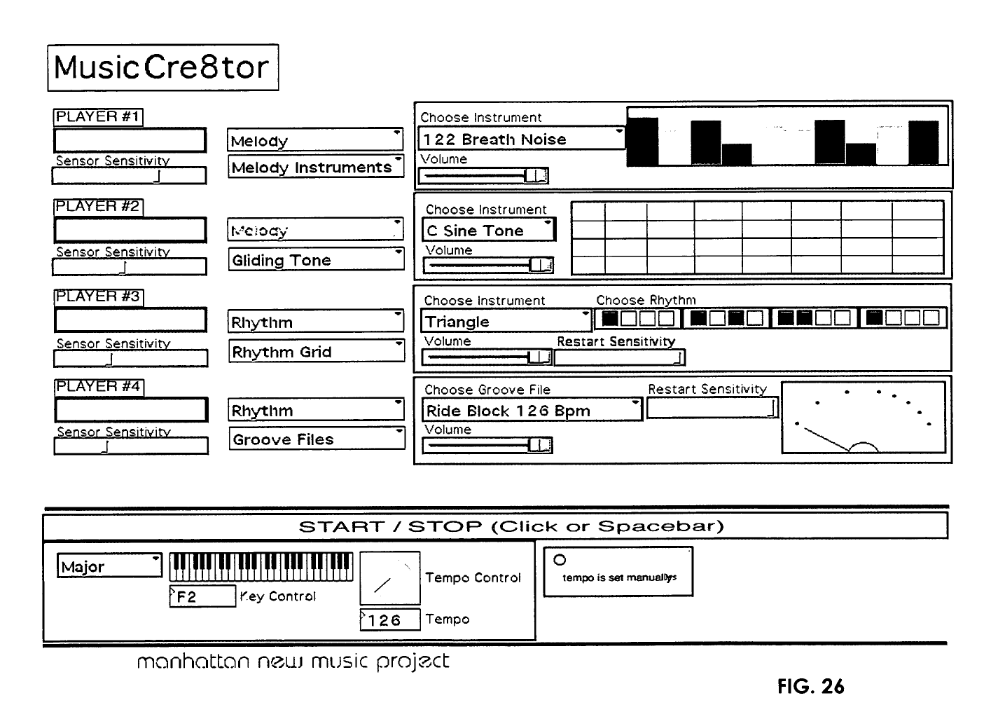

FIG. 26 is a screen shot of an exemplary first embodiment of the GUI showing additional instrument and timbre selections, as well as changes in tonic scale (key), tempo, and synchronization of tempo—as set via the global control panel seen herein at the bottom of the display.

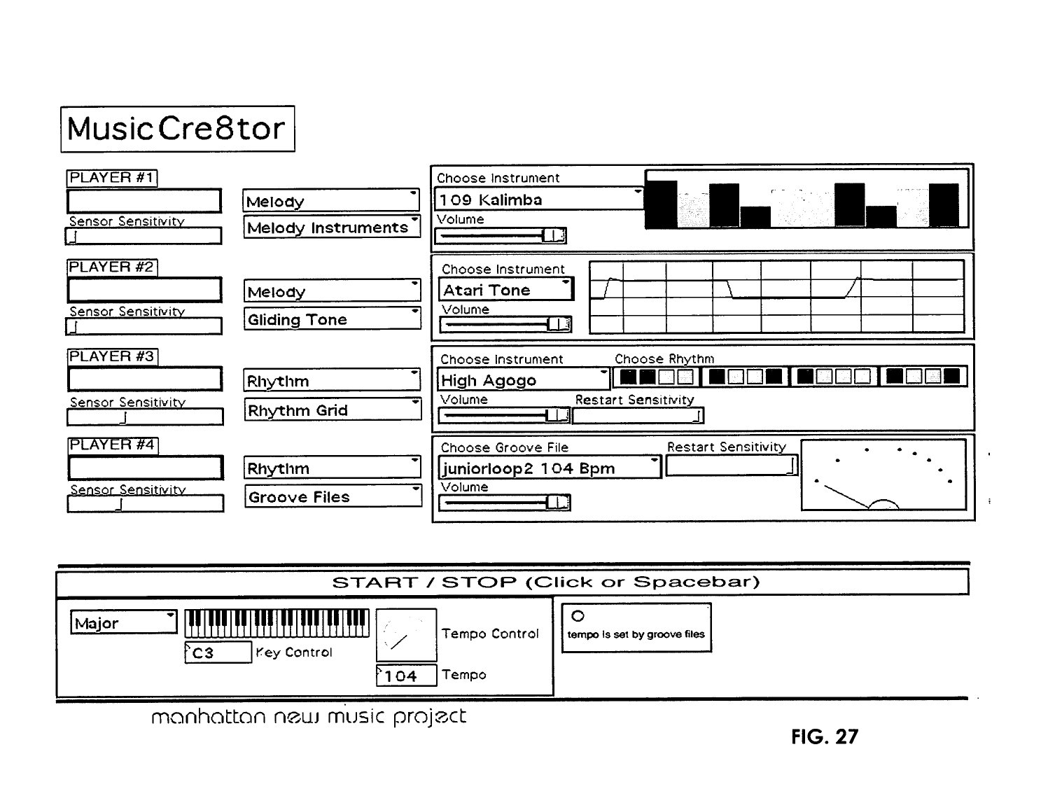

FIG. 27 is a screen shot of an exemplary first embodiment of the GUI showing additional instrument and timbre selections, as well as changes in tonic scale (key), tempo, and synchronization of tempo—as set via the global control panel seen herein at the bottom of the display.

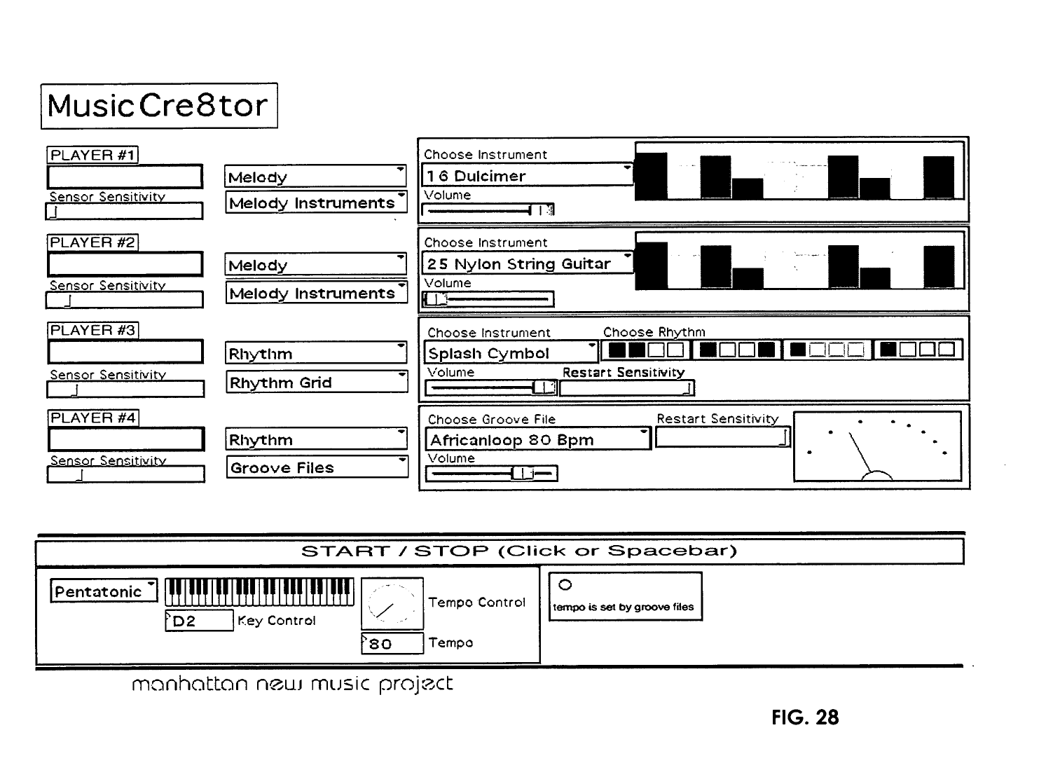

FIG. 28 is a screen shot of an exemplary first embodiment of the GUI showing additional instrument and timbre selections, as well as changes in scale, tonic scale (key), tempo, and synchronization of tempo—as set via the global control panel seen herein at the bottom of the display.

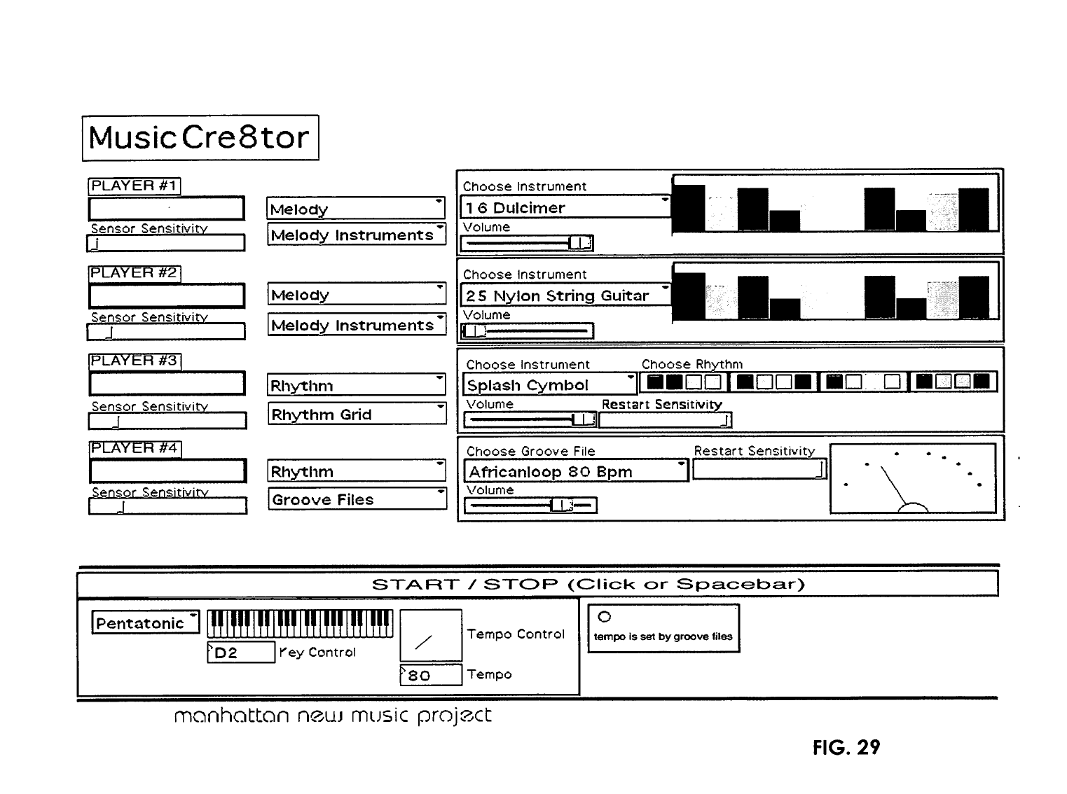

FIG. 29 is a screen shot of an exemplary first embodiment of the GUI showing additional instrument and timbre selections.

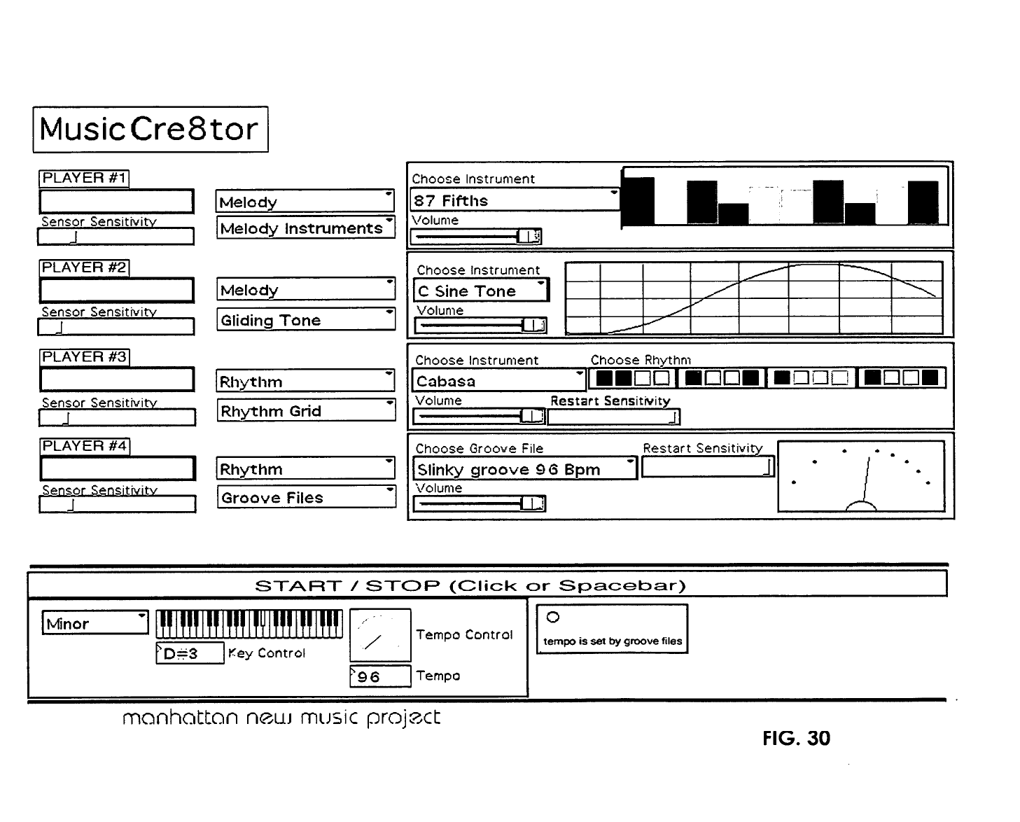

FIG. 30 is a screen shot of an exemplary first embodiment of the GUI showing additional instrument and timbre selections, as well as changes in scale, tonic scale (key), tempo, and synchronization of tempo—as set via the global control panel seen herein at the bottom of the display. Changes in the display panel can be seen as the instrument and timbre are varied. Note for example the difference in the display on the display panel for player #2 here (C sine tone) versus, for example, FIG. 28 (Atari tone). In the present view, different timbres are selected for each player.

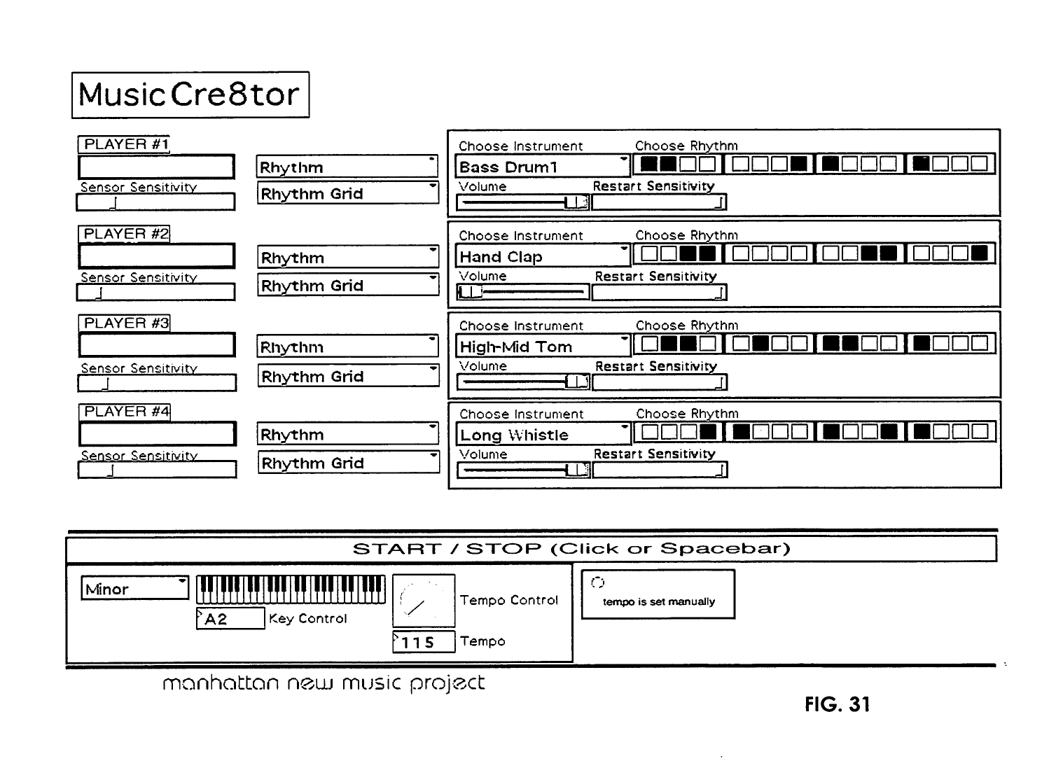

FIG. 31 is a screen shot of an exemplary first embodiment of the GUI showing additional instrument and timbre selections, as well as changes in scale, tonic scale (key), tempo, and synchronization of tempo—as set via the global control panel seen herein at the bottom of the display. Changes in the display panel can be seen as the instrument and timbre are varied. In the present view, all instruments are rhythm grid instruments and different timbres are selected for each player.

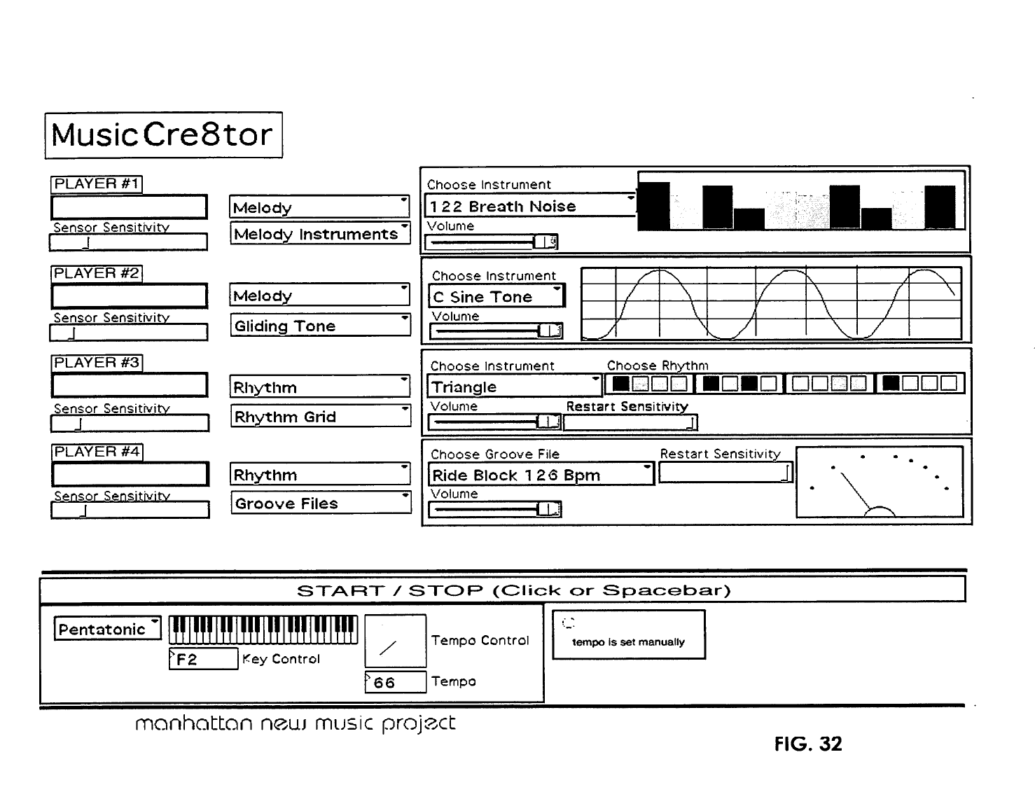

FIG. 32 is a screen shot of an exemplary first embodiment of the GUI showing additional instrument and timbre selections, as well as changes in scale, tonic scale (key), tempo, and synchronization of tempo (here, manually set, not synchronized)—as set via the global control panel seen herein at the bottom of the display. Changes in the display panel can be seen as the instrument and timbre are varied.

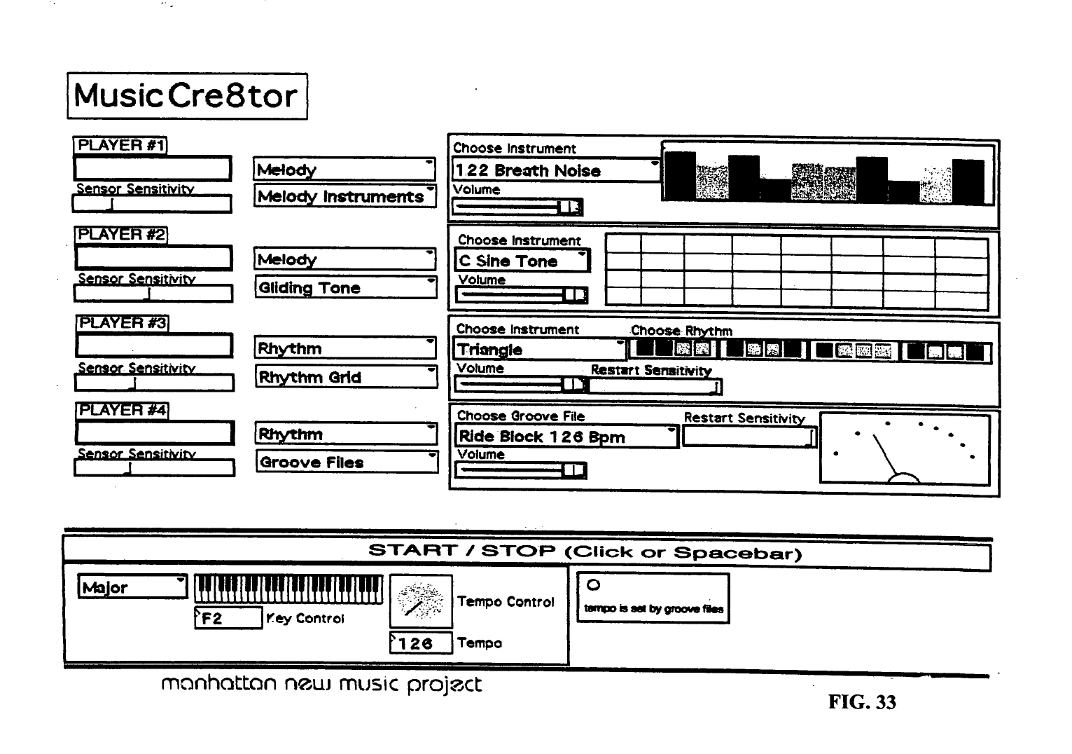

FIG. 33 is a screen shot of an exemplary first embodiment of the GUI showing additional instrument and timbre selections, as well as changes in scale, tonic scale (key), tempo, and synchronization of tempo—as set via the global control panel seen herein at the bottom of the display. Changes in the display panel can be seen as the instrument and timbre are varied. In the present view, a variety of instruments and timbres are shown. In the Global Control Panel, Tonic Scale has been changed to F2 and tempo, which is synchronized with the groove file, is set at 126.

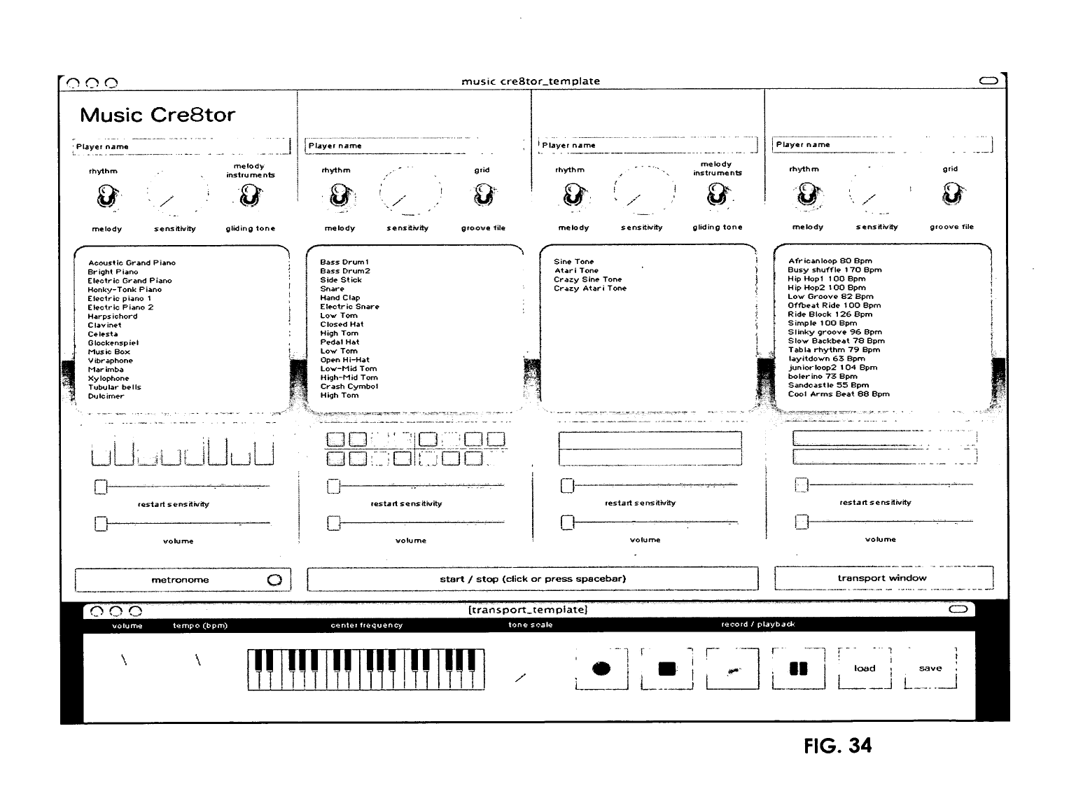

FIG. 34 is a screen shot of an exemplary second embodiment of the GUI showing an exemplary display of four different instruments being selected and some of the timbre options thereunder being displayed. A name or other designation may be entered for each player/player. In the exemplary second embodiment of the GUI shown, there are displays for 4 players/players. For each one, below the player name, there are two switches and a sensitivity dial. The switch to the left is used to select the category of instruments—either melody or rhythm. Once that selection has been made, the switch to the right permits selection of instruments, for example melody instruments or gliding tone if the melody category was chosen, or grid or groove file, if the rhythm category was chosen, respectively.

After the instrument (melody, gliding tone, grid or groove file) has been selected, a drop down menu permits selection of the particular timbre the player will use. As previously described, displays appear to give visual representation of each player's performance. Displays differ depending on the instrument chosen. Rhythm instruments have a restart sensitivity setting and all instruments have general sensitivity settings. Also the global control panel permits changes to scale, tonic, tempo and synchronization with groove file, as well as record and playback.

The save feature enables the user to save a recording. This recording will automatically be saved as a readable soundfile that will be loaded into the user's host computer. The load feature allows this soundfile to be reloaded for playback and incorporated into the system as an instrument of choice for a player.

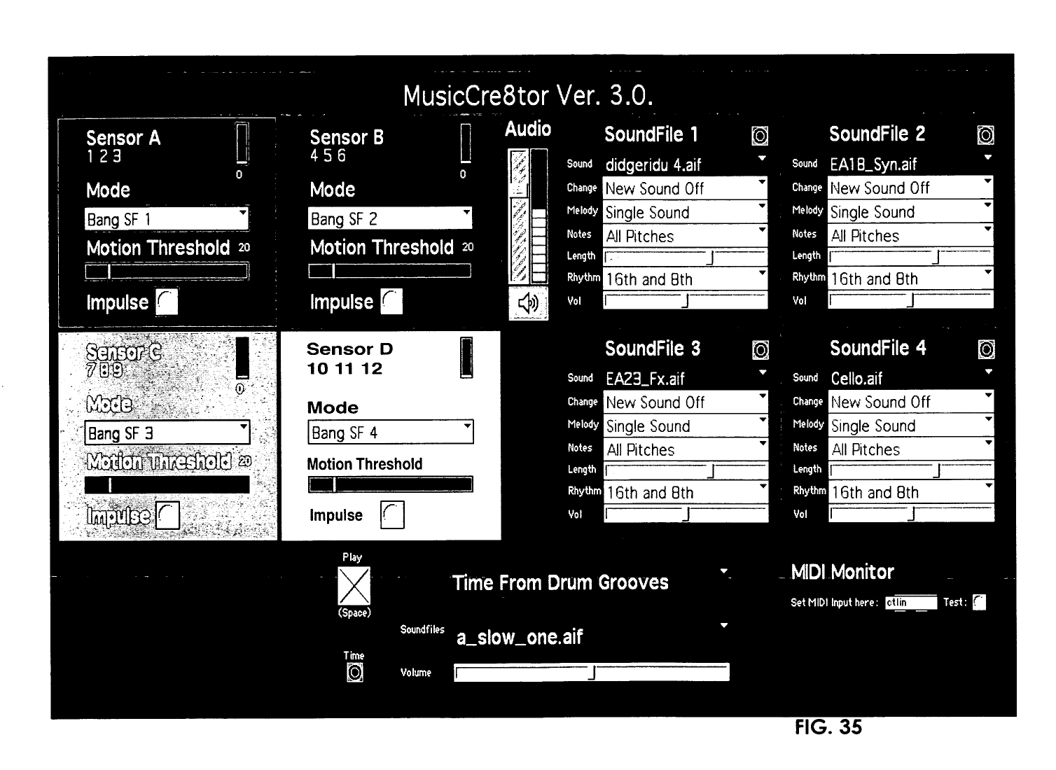

FIG. 35 is a screen shot of an exemplary third embodiment of a GUI

In this embodiment the GUI shows a multiple number of events and actions simultaneously.

Instead of showing the players, this GUI shows the activity of the sensors themselves. In this case there are 4 sensors (A-D) in the left hand side. There is the “motion threshold” which is the sensor sensitivity range as well as the “impulse” which changes color when the sensor is triggered. The mode is how the sensor is being use or manipulated. In the middle, the user can see the audio input led signal, and to the right, there are 4 soundfile options. Up to 4 sensors can be used simultaneously to play each of four different soundfiles and modes contemporaneously, although multiple sensors can be used to play two or more variations of the same soundfiles and modes. This means that up to 4 players can play at a time, with each having one sensor, or one or more players can have more than one sensor (e.g., one player with 4 sensors, 2 players with 2 sensors each, etc.) These four boxes also show what kind of rhythm is being played as well. The “time from drum grooves” shows the metronome markings as well as the beat. The MIDI monitor is a place for the user to go to check the incoming MIDI signal from the Sensor Box. The global volume for all players is on the bottom of this GUI.

1-6. (canceled)

7. A system for composing an auditory and visual expression comprising more than one musical devices, each music device comprising:
a computer coupled to one or more input devices, each of said one or more input devices capable of sensing a change in state, and each of said one or more input devices capable of generating a signal based on said change in state;
an interface coupled to said computer and coupled to each of said one or more input devices, wherein said interface is capable of communicating said signal from said one or more input devices to said computer, and wherein said computer is capable of converting said signal into sound data and display data;
a user interface coupled to said computer and said interface, wherein said user interface is capable of setting a user calibration;
a sound emitting device coupled to said computer to emit said sound data; and a display device for displaying said display data;
wherein each music device is played by a user.

8. The system of claim 7 wherein said one or more input devices are selected from a group of input devices comprising: motion sensor, accelerometer, light sensor, pressure sensor, switch, magnetic sensor, potentiometer, thermistor, proximity sensor, flex/bend sensor, wind sensor, air sensor, force sensor, solenoid, keyboard, computer mouse, and gaming device.

9. The system of claim 7 wherein each of said one or more input devices is further capable of generating a signal based on a user calibrated range of motion.

10. The system of claim 7 wherein said computer converts said sound data and display data based on said user calibration.

11. The system of claim 7 wherein said one or more input devices is wirelessly coupled to said computer.

12. The system of claim 7 wherein said user interface is capable of receiving an input for a selected instrument.

13. The system of claim 7 further comprising a MIDI interface for converting a input device signal into sound data.

14. The system of claim 7 further comprising a storage component capable of recording said signal, said sound data, and said display data.

15. The system of claim 14 wherein said storage component is further capable of storing said user calibration.

16. The system of claim 7 wherein said user interface is further adapted for input of a mode, wherein said mode affects a conversion of said signal into said sound data and said visual data.

17. A method for composing an auditory and visual expression using more than one musical device, said method comprising:
sensing a change in state using one or more input devices, wherein said one or more input devices are being used by more than one user;
receiving a user calibration for each of said more than one user;
generating a signal based on said sensed change in state;
converting said signal into sound data and display data;
emitting said sound data; and
displaying said display data.

18. The method of claim 17 wherein said one or more input devices are selected from a group of input devices comprising: motion sensor, accelerometer, light sensor, pressure sensor, switch, magnetic sensor, potentiometer, thermistor, proximity sensor, flex/bend sensor, wind sensor, air sensor, force sensor, solenoid, keyboard, computer mouse, and gaming device.

19. The method of claim 17 further comprising generating a signal based on a user calibrated range of motion.

20. The method of claim 17 further comprising selecting an instrument.

21. The method of claim 17 wherein converting said signal into sound data and display data is based on said user calibration.

22. The method of claim 17 further comprising storing said signal, said sound data, and said display data.

23. The method of claim 17 further comprising storing said user calibration.

24. The method of claim 17 further comprising selecting a mode, wherein said mode affects a conversion of said signal into said sound data and said visual data.
